(19) United States
(12) Patent Application Publication
(10) Pub. No.: US 2017/0083838 A1
(43) Pub. Date: Mar. 23, 2017

(54) Computer-Aided System for Improving Return on Assets

(71) Applicant: Profit Velocity Solutions, LLC, Greenbrae, CA (US)

(72) Inventors: Michael Lee Rothschild, Greenbrae, CA (US); Ameet Kumar, Dublin, CA (US); Jake Alan Farmer, Wilmington, NC (US); Gilbert Gee-yin Chan, Hayward, CA (US); Mark Shwert, Woodland Hills, CA (US)

(73) Assignee: Profit Velocity Solutions, LLC, Greenbrae, CA (US)

(21) Appl. No.: 15/370,269

(22) Filed: Dec. 6, 2016

Related U.S. Application Data
(63) Continuation-in-part of application No. 14/022,423, filed on Sep. 10, 2013, now abandoned.
(60) Provisional application No. 61/698,729, filed on Sep. 10, 2012.

(51) Int. Cl. G06Q 10/06

(52) U.S. Cl. CPC G06Q 10/067; G06Q 10/06313

(57) ABSTRACT

Management software for increasing of return on assets (ROA) and, more particularly, to software-enabled systems, methods and apparatus using the metric profit per asset-hour (PPAH) for measuring and increasing profit generated by asset utilization to increase return on assets (ROA) and likewise return on equity (ROE).

### CROSS REFERENCE TO RELATED APPLICATIONS

This patent application is a Continuation-in-Part of and claims priority from U.S. patent application Ser. No. 14/962,659, filed Dec. 8, 2015 which claims priority from U.S. patent application Ser. No. 14/022,423 filed Sep. 10, 2013 which claims priority from U.S. provisional patent application Ser. No. 61/698,729, filed Sep. 10, 2012, and also claims priority from U.S. provisional patent application Ser. No. 62/089,187, filed Dec. 8, 2014, the entirety of which is incorporated herein by this reference thereto.

### BACKGROUND OF THE INVENTION

Technical Field

This invention relates generally to the field of management software for increasing return on equity (ROE) and, more particularly, to software-enabled systems, methods and apparatus for measuring and increasing profit generated by asset utilization to increase return on assets (ROA).

Description of the Related Art

Return on equity (ROE) is the highest summary level metric by which the historical financial performance of companies and management teams are judged by investors and the greater financial community. Return on equity measures the rate of growth of the shareholder equity in a business as profit produced in each new time period is added to cumulative past profits and equity investments made in prior times. ROE is the ultimate goal in financial performance because the higher the ROE ratio, the faster the equity of shareholders is growing, and hence the faster the company's share price tends to rise.

Referring to FIG. 1A, the widely taught DuPont™ (“DuPont”) “profit formula” 100 is often used to identify the factors driving ROE. ROE 111 is comprised of three interacting financial ratios: assets/equity (leverage) 112, profit/units (margin) 113, and units/assets (asset turnover) 114 (shown in various algebraic representations (a)-(d). Algebraically, ROE=leverage×margin×turnover, which reveals how effectively a company's management used investors' equity over a past period (typically a year or a quarter).

The leverage ratio (assets per equity) 112 is largely determined by conditions in external financial markets and is not under the direct control of a company's management. Holding leverage to a constant, “f” 122 then, the remaining ratios that management can influence are margin 113 (profit per units) and asset turnover (units per assets) 114. Taken together, margin 113×asset turnover 114=ROA 110. Return on assets (ROA) 110 is another commonly used summary level financial indicator which tends to be monitored on an annual, semi-annual or quarterly basis. The ROA ratio indicates how effective management's decisions have been in a prior time period in generating profit from all the assets under its control.

The assets performance and unit production components are reported in average amounts over the entire period reported, which does not provide the underlying and highly detailed information needed to produce an operational analysis of the past interplay that existed between the various underlying factors that determined each nor a forward-looking analysis of how those factors will influence future performance.

Instead of relying on the summary level metric of ROA to evaluate options for improving financial performance, managements rely on the detailed measurement of margin (profit per unit). A wide variety of profit analysis and product costing systems, ERP systems, and other systems calculate margin in great detail. However, controlling margin alone is not the most efficient way to drive up ROA. Again, ROA=Margin×Asset Turnover (units per assets). To gain greater control over ROA performance, the present invention provides the tools by which management can proactively manage both Margin and Asset Turnover together at a level of detail that includes for each transaction, order, production batch, customer, etc.

Although ROA is a vital high-level indicator of management's past performance, this backward-looking, historical summary level indicator of financial performance is of minimal usefulness to operating managers and executives who must make detailed, forward-looking, hour-to-hour, day-to-day, month-to-month decisions and plans regarding the most profitable use of assets. In short, while improving ROA is a vital goal of managers and executives, ROA itself is so aggregated that it cannot practically serve as a useful decision-making metric in business operations.

There are many computer-aided systems in the prior art that perform various tasks in a manufacturing environment. These systems are referred to herein, collectively, as transactional processing management systems (TPM Systems) and include by way of example and without limitation: enterprise resource planning systems (ERP), financial reporting systems (FRS), inventory and invoicing systems (IIS), marketing systems (MS), production control systems (PC), and manufacturing execution systems (MES). TPM Systems typically contain a substantial amount of data on all phases of a manufacturing business as more fully described below. These systems all collect data and apply rules that are designed to assist management in increasing ROA.

FIG. 1B is a block diagram representation of a typical prior art TPM System 120 implemented on a computer 123. Computer 123: receives input from a TPM System Input 121; has access to a TPM System Information Database 129; has access to TPM Software from TPM Software Store 125 and; generates a TPM System Output 127 that in some instances controls Facility Operations 130 such as producing shipping tickets.

The following are non-exhaustive examples of specific TPM Systems 120 and their corresponding TPM System Input 121 and TPM System Output 127.
An ERP tracks the resources such as materials, production capacity, orders, and payroll of a business, accepts TPM System Input 121 such as raw material quantity and labor rates, and provides TPM System Output 127 and Facility Operation 130 such as finished goods quantity and labor costs.
An FRS reports on assets, liabilities, equity, income and expenses (cost), and cash flows of a business, accepts TPM System Input 121 such as raw material cost and inventory value, and provides TPM System Output 127 such as finished goods costs and selling price.
An IIS creates and prints invoices, quotations, order forms, and also calculates taxes, margins, and shipping requirements of a business, accepts TPM System Input 121 such as a customer order and ship-to address, and provides TPM System Output 127 and Facility Operation 130 such as a shipping ticket and tax rate.
An MS identifies potential new transactions and qualifies, connects, and engages target customers of a business, accepts TPM System Input 121 such as prospect and revenue potential, and provides TPM System Output 127 and Facility Operation 130 such as customer and revenue forecast.
A PC monitors and controls a large physical facility by actions and decisions during production, including predicting, planning and scheduling work as constrained by manpower, materials, and other capacity restrictions, accepts TPM System Input 121 such as product delivery guarantee and material supplier, and provides TPM System Output 127 and Facility Operation 130 such as production priority and scheduling exceptions.
An MES is a control system for managing and up-to-the-minute monitoring of work-in process (WIP) in a physical facility (factory), including monitoring machines, robots, and employees, accepts TPM System Input 121 such as asset capacity and maintenance exceptions, and provides TPM System Output 127 and Facility Operation 130 such as run-time status and down-time class.

TPM System Information Store 129 can provide input data to computer 123 including without limitation data on products sold, sales volumes (quantity), price per unit, costs (of product) (including direct and indirect costs), assets used in manufacturing of each product, asset times, qualitative information on customers and products, seasonal material cost variations, changing prices, changing product volumes, and much more.

While prior art TPM Systems store and can output vast amounts of data for particular purposes, these are unsystematic data for the purpose of maximizing the ROE through an improved understanding and control of the factors impacting ROA (Margin and Asset Turnover). Consequently, such prior art TPM Systems do not provide the detailed data values made possible by the present invention that can better lead to higher ROA (in order to achieve the ultimate goal of higher ROE). Lacking access to these detailed data values, management teams have traditionally measured and pursued the improvement of the only useful detailed profit indicator available to them—margin. To enable management teams to effectively pursue shareholders' goal of higher ROA (to yield a higher ROE), the present invention provides management teams with detailed data of those values in addition to margin that measure ROA: asset turnover, which, together with margin, measure profit per asset-time. The invention calculates, displays and makes available for use the metric profit per asset-time, incorporating both margin 113 and asset turnover 114, at any level of granularity desired, as part of a reporting and forward-planning decision-support system which enables management teams to better pursue the metric their investors actually want, higher ROA in order to achieve higher ROE—faster share price growth.

### SUMMARY OF INVENTION

A primary element of the present invention is the implementation of the metric that measures the profit produced by an asset over a unit of time (second, minute, hour, etc.). This metric is expressed throughout as “profit per asset-hour” hereafter, also “PPAH.”

While the metric of profit per asset-time is expressed with the unit of time being an hour, the invention is not so limited. An hour may, in most cases, be the most convenient unit of time to use, but in any particular case, a different unit of time may prove more useful and could be used without departing from the invention, as will be obvious from what follows. Thus, “PPAH” shall be used herein in describing and understanding the invention as a designation of “profit per asset-unit of time” whether that “unit of time” is an hour, minute or some other temporal measure.

The highly detailed measurement of the speed at which manufacturing assets deliver profit as implemented by the present invention can guide management decision-making in accurately anticipating, pursuing, and accepting orders and allocating production capacity against those orders to get those assets to make money faster. PPAH also provides information that helps decision-makers consider different futures where they adjust customer, sales, pricing, and manufacturing plans in order to improve asset utilization and capital investment activities to increase ROA 110. By exploiting operational information revealed by implementing the metric PPAH, as described herein, decision-makers are provided with objective data on which to better assess manufacturing, sales, and customer opportunities, and are provided with a tool to better anticipate future results and adjust decision-making pertaining to product mix, customer mix, and asset mix to drive the maximization of ROA 110.

The software, methods, apparatus and systems of the present invention provide management with powerful new insights into what has driven ROA performance in the past and what are the best decisions moving forward to increase ROA 110.

More specifically, in one embodiment, the present invention provides software that causes a computer to: extract selected data from one or more non-transitory databases of one or more TPM Systems, such as enterprise resource planning systems, production management systems, other legacy systems, open source systems, proprietary systems, or the like; calculate various asset-time based values from the extracted data including PPAH; and display the calculated results on a digital display device in an interactive format.

The invention departs from known systems by calculating and reporting profit over a selected time period factoring in products, customers, margins, productivity and any number of other variables that have an impact on the metric PPAH. Importantly, the metric PPAH can be calculated, reported, and projected for individual assets, customers, products, customer-product mix, etc. The invention for the first time provides managers with a clear vision of the speed of making profits as a function of one or more of products, customers, margins, productivity and any number of other variables that have an impact on the metric PPAH.

Because margin 113 and asset turnover 114 have to be measured and managed jointly to improve ROA 110, such improvement is not necessarily achieved by simply adjusting these variables separately. The adjustment of margin 113 and asset turnover 114 to increase ROA 110 usually involves making tradeoffs—increases and/or decreases in component values—within the constrained limits of the components to yield improved ROA. Prior to the present invention, margin 113 has been almost universally used as the driving metric for profitability analysis and management. With the present invention providing management with greater insights revealed by implementation of the metric PPAH, far more refined profit analysis and planning is made possible, revealing new opportunities for management to increase ROA.

Asset turnover 114 is traditionally measured only on a consolidated level for the various products of the company taken together, over all the assets used on an annual, semi-annual or quarterly basis. Although the raw data necessary to calculate the PPAH metric at the hourly level, for example, and for each transaction, order, asset, each customer, product, etc., may be captured by production control systems for the various products made by a company, prior to the present invention, this data has not been extracted and processed for each transaction, order, asset, customer, product, etc., and integrated with other available data in a form useful for aiding management in analyzing past performance and making prospective marketing, sales, production, asset investment decisions with the continuous improvement of ROA 110 as the guide.

While the present invention has application to all industries, it has the greatest impact on the manufacturing sector where the assets employed (be they natural, man-made, or human) in production are significant. This is especially true for manufacturers that produce a wide variety of products, stock-keeping units (SKUs), for an array of customers, often including multiple production facilities (hereafter, also referred to as “High Mix” industries). In High Mix industries such as chemicals, steel, semiconductors, electronic components, packaging, and paper, or the like, a single company may often produce hundreds, if not tens of thousands, of distinct product types and items. While such High Mix product manufacturers attempt to measure and control the unit profit margin 113 of their products, their systems do not enable them to measure and manage PPAH, or the rate of cash contribution or profit flow per hour of asset utilization for a given transaction, order, product, customer, asset or any other variable that contributes to the calculation of ROA 110. Manufacturers are also unable, with prior art systems, to discern the sensitive and non-linear relationship between margin 113 and asset turnover 114. Profit analysis systems are traditionally based on margin per unit 113, not profit per asset-unit of time (PPAH). Production control (PC) or manufacturing execution systems (MES) measure machine time used and physical unit throughput rates, but lack the integration with cost and financial information required to calculate PPAH which directly drives ROA 110. With the present invention's ability to measure, report, and explore the future impact of upcoming business decisions on PPAH and therefore on ROA 110, decision-makers in marketing, sales, production, operations, finance, and all other functional areas of a complex enterprise, have, for the first time, a tool to analyze, accurately anticipate, plan, and positively influence the rate of cash contribution or profit per unit of time (PPAH). The present invention, for the first time, makes it possible for management teams to see and understand precisely—down to the transaction, or sales order level, and the like where trade-off adjustments to prices, costs, productivity, volume, and product mix may be used to speed up the overall flow of profits through the assets and thereby improve ROA 110.

It is one aspect of the present invention to provide a computer-aided system that calculates and presents a graphic representation of a profit per asset-hour (PPAH) metric for a company manufacturing a plurality of different products using assets and having a plurality of TPM System databases. The system includes: an Input Data database containing selected data from TPM System databases; a processor disposed to receive a dataset from the Input Data database; a Software Store operatively disposed with respect to the processor containing instructions (rules) which, when executed by the processor, generates a plurality of calculated results based on the dataset from the Input Data database comprising: manufacturing ratios, profit ratios, the metric profit per asset-hour (PPAH) and Gain Attributes; a PPAH database operatively disposed with respect to the processor for storing the calculated results and the dataset from Input Data database used in generating the calculated results; a digital display device operatively disposed with respect to the PPAH database for displaying data in the PPAH database; and a TPM System having a TPM System database storing manufacturing and profit ratios and adapted to accept and replace manufacturing and profit ratios recalculated based on PPAH by the present invention.

It is another aspect of the present invention to provide a method of operating a TPM System using a profit per asset-hour planning system (PPAHPS) comprising processing and storage units for increasing return on assets (ROA) 110 for a company producing a plurality of different products with assets and having TPM System databases. The method comprises: extracting and storing in an Input Data database compiled and consolidated selected datasets of variable data from at least one existing TPM System database, the variable data comprising any of sales quantities, prices, product costs, operating expenses, asset values, production throughput rates (asset time), and other production information as well as information on customers and products and transactional information comprising any of seasonal raw-material cost changes, periodic demand increases, and competitive price variations; generating profit ratios based on the PPAH metric using the compiled and consolidated data and information from the Input Data database; providing the generated PPAH-based profit ratios to the TPM System database; and operating the TPM System using the PPAH-based generated profit ratios.

It is yet another aspect of the invention to provide a machine-readable storage medium having stored thereon a computer program for generating quantitative variables including profit per asset-hour (PPAH) as a guide to increase return on assets (ROA) 110 for a company using assets to produce a plurality of different products, the computer program comprising a routine of set instructions for causing the machine to perform the steps of: extracting selected data from one or more non-transitory TPM System databases; calculating various variables from the extracted TPM System databases including profit per asset-hour (PPAH) and Gain Attributes; and displaying calculated results on a digital display device.

### BRIEF DESCRIPTION OF THE DRAWINGS

FIG. 1A is a schematic diagram that depicts algebraically the DuPont™ formula for return on investment (ROE) and return on assets (ROA) expressed in various algebraic notations (a)-(e) according to the prior art;

FIG. 1B is a block diagram of a TPM System according to the prior art;

FIG. 2 is a schematic diagram that depicts the formula for profit per asset-hour (PPAH) according to the present invention and as useful for individual assets, products, customers, etc.;

FIG. 3 is a flowchart of the PPAH system of an embodiment of the invention including process steps and components;

FIG. 4 is a block diagram of the integrated profit per asset-hour planning system (PPAHPS) according to an embodiment of the invention;

FIG. 5 is a graph depicting an example of a way to chart PPAH for profit maximization according to an embodiment of the invention;

FIG. 6 is a block schematic diagram of a system in the exemplary form of a computer system according to an embodiment;

FIG. 7 is an exemplary PPAH-formatted dataset;

FIG. 8 is a diagram that depicts the formula for Gain (Loss) over time;

FIG. 9 is a table that describes variables and formulas for calculating different types of Gain in a business.

FIG. 10 is a schematic that depicts the hierarchical relationship of Gross Cash Contribution Gain to its components Price Gain, Time Volume Gain, and Cost Gain, and further Time Volume Gain to its components Product Time Volume Gain, Product Time Mix Gain, Product Time Productivity Gain; and Unit Volume Gain to its components Product Unit Volume Gain and Product Unit Mix Gain;

FIG. 11 is a diagram that depicts the formula for Gross Cash Contribution Gain;

FIG. 12 is a diagram that depicts the formula for Product Price Gain;

FIG. 13 is a diagram that depicts the formula for Product Raw Material Cost Gain;

FIG. 14 is a diagram that depicts the formula for Gross Time Volume Gain;

FIG. 15 is a diagram that depicts the formula for Product Time Volume Gain;

FIG. 16 is a diagram that depicts the formula for Product Time Mix Gain;

FIG. 17 is a diagram that depicts the formula for Product Time Productivity Gain;

FIG. 18 is a diagram that depicts the formula for Gross Units Volume Gain;

FIG. 19 is a diagram that depicts the formula for Product Unit Volume Gain;

FIG. 20 is a diagram that depicts the formula for Product Unit Mix Gain;

FIG. 21 is a schematic that depicts the hierarchical relationship of Net Income Gain to its components Fixed Manufacturing Expense Gain, Fixed Other Expense Gain, and General and Administrative Expense Gain.

FIG. 22 is a diagram that depicts the formula for Net Income Gain;

FIG. 23 is a diagram that depicts the formula for Fixed Manufacturing Expense Gain;

FIG. 24 is a diagram that depicts the formula for Fixed Other Expense Gain; and

FIG. 25 is a diagram that depicts the formula for General Administrative Expense Gain.

### DETAILED DESCRIPTION OF THE INVENTION

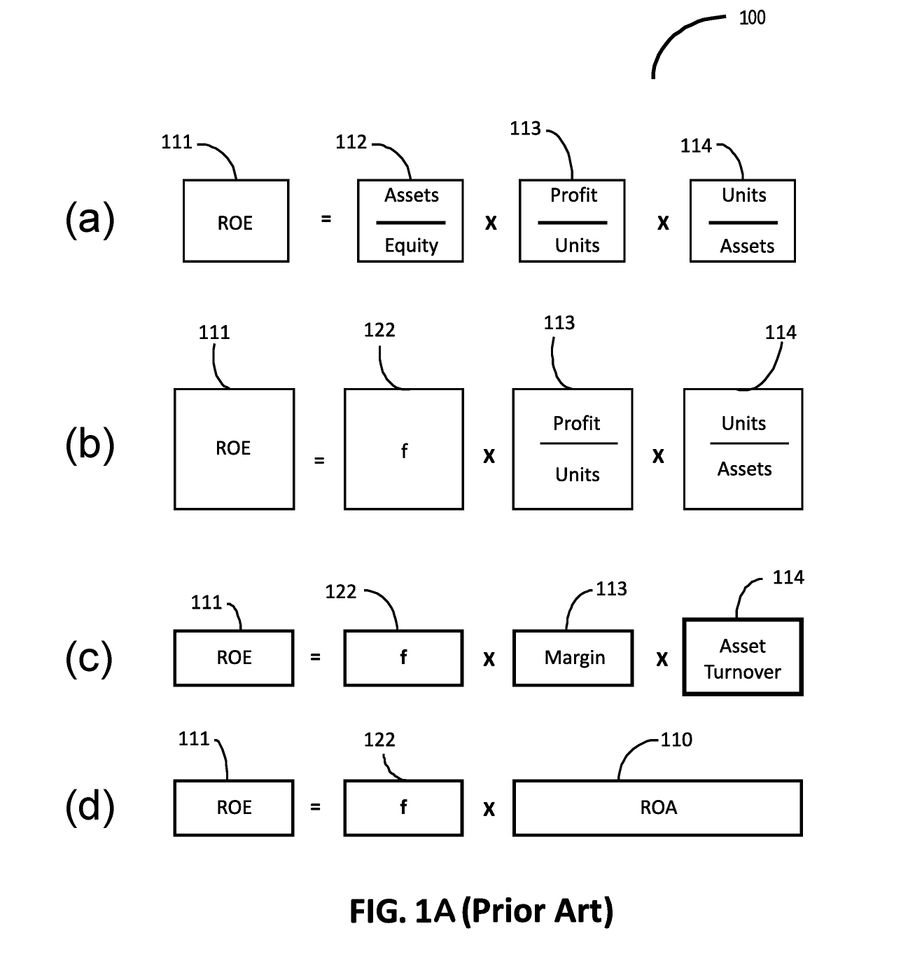

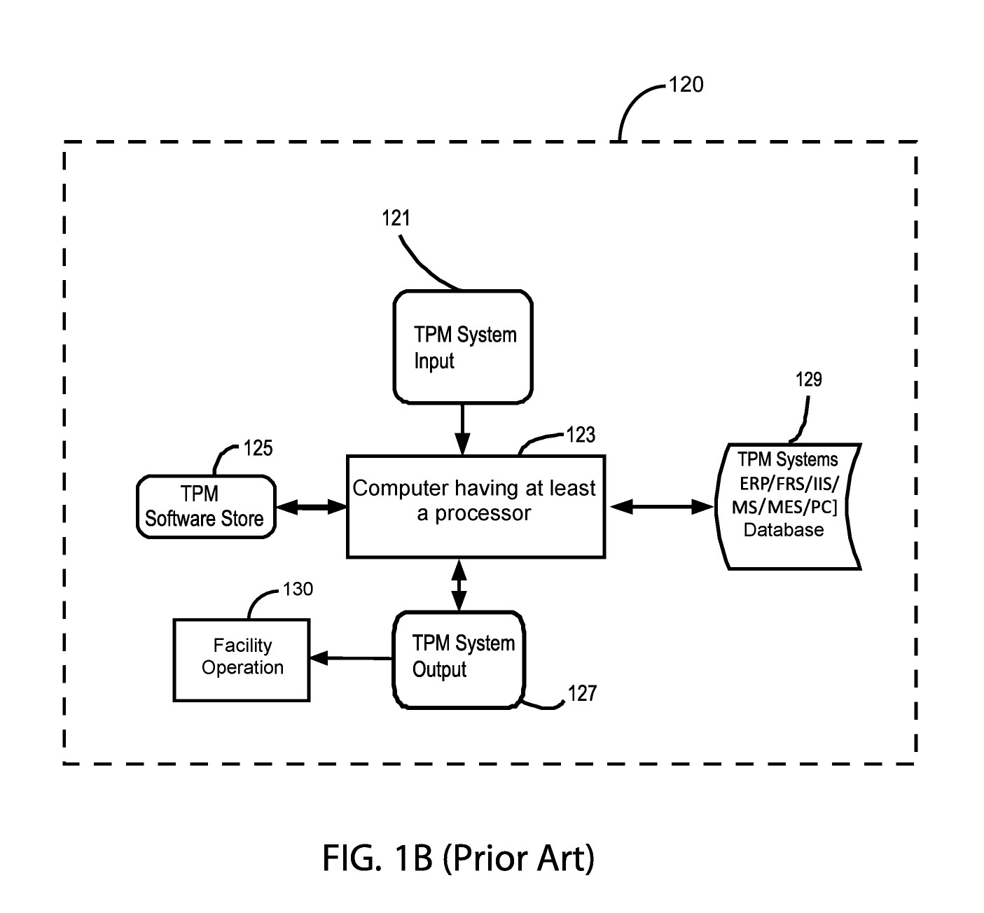

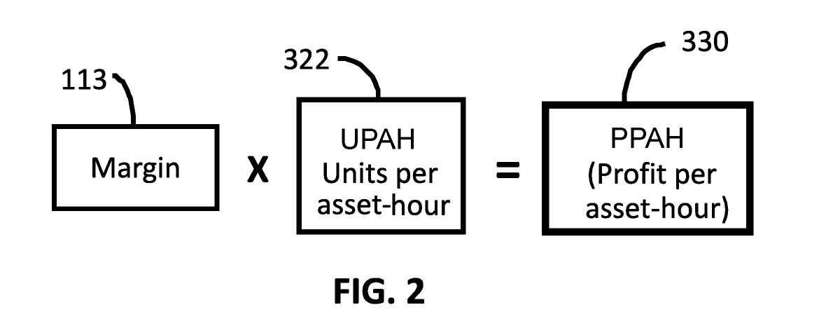

Referring to FIGS. 1A and 2, the metric Profit Per Asset-Hour (PPAH) 330 is the metric of margin 113 multiplied by units per asset hour (UPAH) 322. Using this metric in the manner fully described below enables the performance character of manufacturing assets to be matched to the specific products they produce, including the product margin returned by the asset over time, by product, by customer, by order, or raw material used, and any other known factor that impacts or influences the value of PPAH 330.

PPAH 330 also provides a basis for making decisions that can result in improved ROA 110 and hence ROE 101. By extracting and aggregating the output units from the assets for a specified period of time, such as a minute, an hour, or any other measurable time unit, based on the type of products manufactured, and knowing the margin 113 of the products manufactured, PPAH 330 can be anticipated, calculated, evaluated, and adjusted to produce increases in ROA.

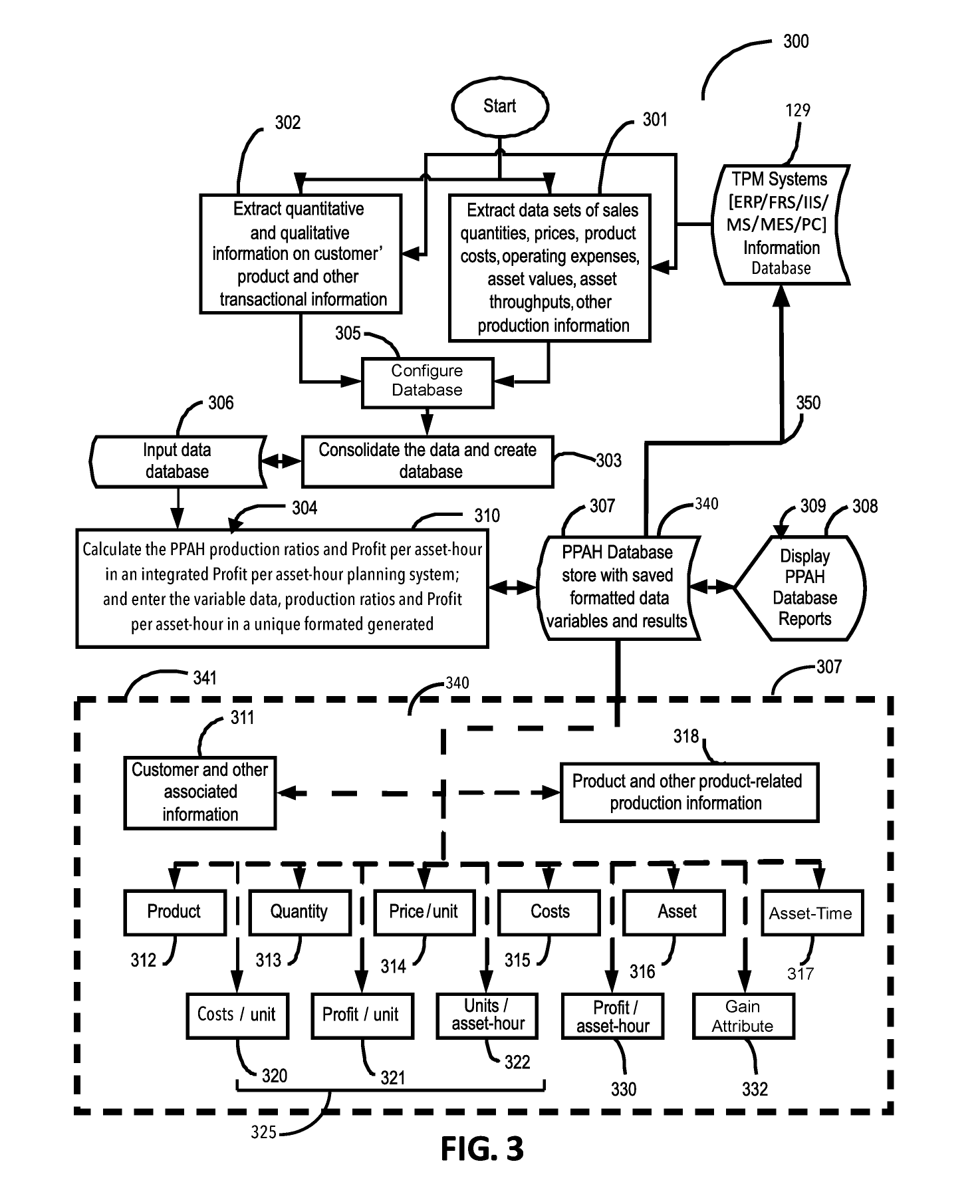

Referring to FIG. 3, in one embodiment, a computer-implemented system 300 having sufficient processing power and storage capability with a minimum of components generates a PPAH database 307 including saved formatted data variables and calculated results (dataset 340) illustrated in expanded detail in the dashed framed window 341.

Dataset 340 in PPAH database 307 includes transaction-level data and information extracted from a company's existing TPM System Information Database 129 (see FIG. 1B) which may include but is not limited to: product costs such as direct cost of material and direct labor cost for each product made, as well as indirect costs such as depreciation of equipment and other overheads allocated to individual products. Similarly, other important data that can be extracted includes but are not limited to: pricing details, volume incentives and promotions provided to customers, sales targets, sales forecasts, inventory costs, invoicing details from asset utilization, asset scheduling details, and production throughput rates (asset time). In certain embodiments, system 300 operates to modify the values of data extracted from TPM System Information Database 129, and replace the extracted data with the modified data as indicated by function line 350.

Dataset 340 includes data extracted from TPM System Information Database 129 by method step 301, configured by method step 305, and consolidated by method step 303 and stored in Input Data database 306 and ultimately stored in PPAH database 307 and may include (as shown in frame 341), for example and without limitation, data on products sold 312, sales volumes (quantity) 313, price per unit 314, costs (of product) 315 (including direct and indirect costs), Assets 316 and Asset Time 317 used in manufacturing of each product. Additional qualitative information on customers 311 and products 318 that may be needed to analyze and optimize customer and product mix may be extracted by method step 302 from TPM System Information Database 129, and configured by method step 305, consolidated by method step 303 and stored in Input Data database 306 and ultimately stored in PPAH database 307. In addition, some transactional information such as, but not limited to, seasonal material cost variations, changing prices, changing product volumes, that may impact profit per asset-hour 330 are also extracted by method step 302 from TPM System Information Database 129, and configured by method step 305, consolidated by method step 303 and stored in Input Data database 306 and ultimately stored in PPAH database 307.

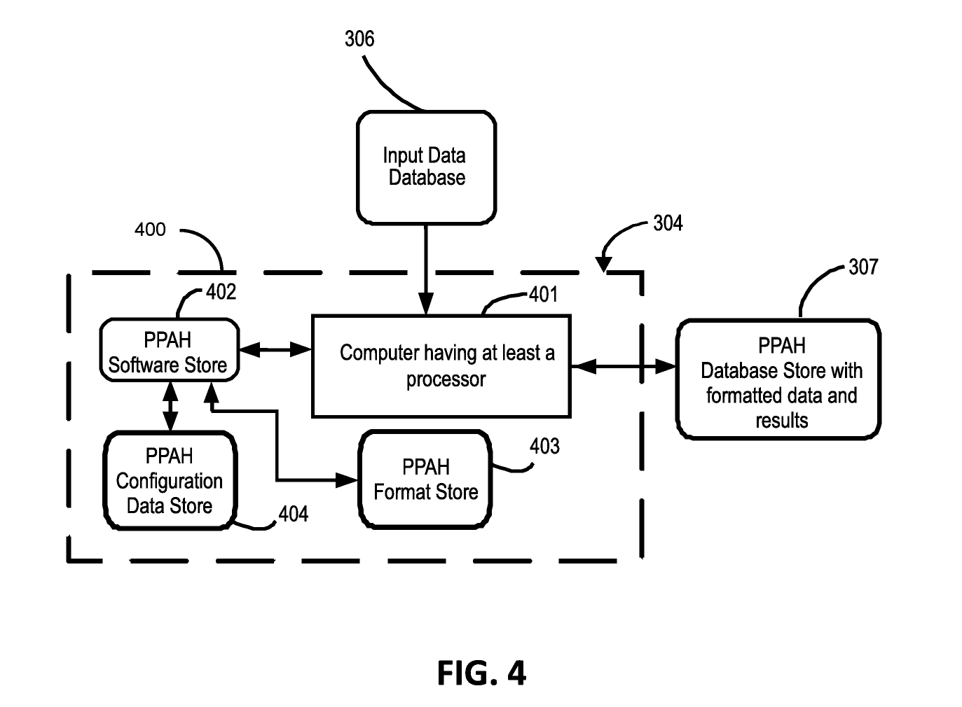

The collected information and data in Input Data database 306 is available to PPAH integrated planning system (PPAHPS) 304 (described in greater detail below in connection with FIG. 4) to make the calculations by method step 310 that produce the key financial and operational ratios that are also included in the dataset 340. These key financial and operational ratios are based on PPAH accounting and include, but are not limited to, cost per unit 320, profit per unit 321, and units per asset-hour 322 (hereafter also referred to collectively as “Key F&O ratios 325”), and the computation of a PPAH 330 for each transaction, order, product, asset, customer, etc. The Key F&O ratios 320 and 321 will, in most cases, differ from the corresponding ratios in TPM Information database 129 which are calculated using only units base accounting.

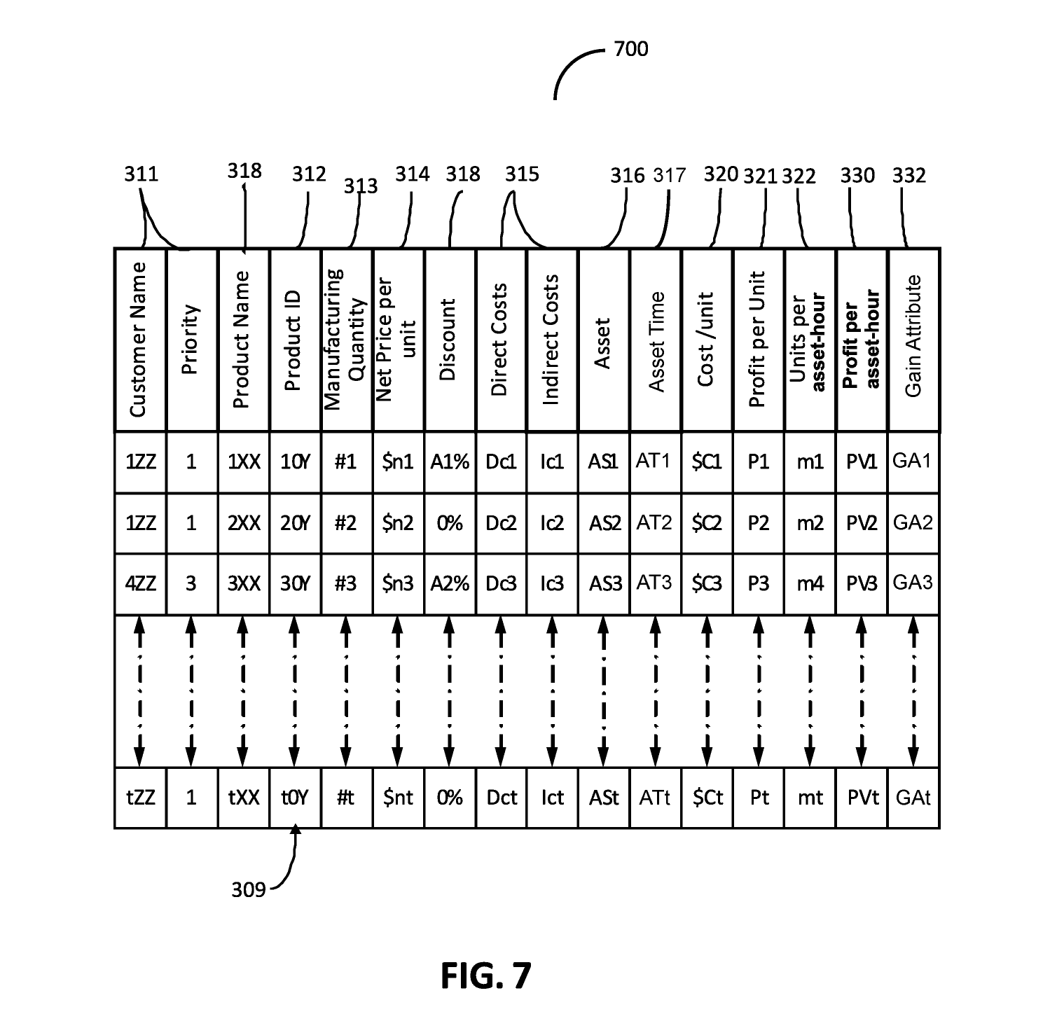

The formatted data variables extracted from TPM System Information Database 129 and stored in Input database 306, along with the Key F&O ratios 325 and computed PPAH 330, comprise dataset 340 stored in the PPAH Database Store 307 from which they can be selectively displayed by method step 308 in a useful interactive format (such as that illustrated in FIG. 7) on a display device 309.

One or more selected, saved, formatted data variables in PPAH Database Store 307 can be changed as described more fully below, in which case, the Key F&O ratios 320 and 321 and PPAH 330 in PPAH Database Store 307 will be recalculated and displayed by method step 308 on display device 309 whereby the changes to Key F&O ratios 320 and 321 and PPAH 330 can be readily observed. In at least one embodiment, the calculated Key F&O ratios 320 and 321 in PPAH Database Store 307 are, by method step 350, substituted for corresponding ratios (of different values) in TPM System Information Database 129 which typically will result in a different output 127 from TPM Computer System 120 (see FIG. 1B), which can impact activities controlled by output 127 and Facility Operation 130 such as, for example, priority machine loading.

Referring to FIGS. 3 and 4, PPAHPS 304, which is operatively disposed with regard to Input Data Database 306 and PPAH Database Store 307, is implemented on a computer system 400 comprising a computer 401 having at least one processor for handling the data processing needs, a PPAH Configuration Data Store 404 containing business process flow and data transformational rules and a PPAH software store 402 that stores software that, when implemented by computer 401, causes the computer 401 to, among other things, read, integrate, and format data from Input Data database 306 and calculate the Key F&O ratios 325 and PPAH 330 which, together with the other elements of data set 340, are stored in PPAH Database Store 307 in a PPAH format from PPAH Format Store 403, such as the format of PPAH formatted dataset 700 shown in FIG. 7 and described below. This PPAH format enables the computation of PPAH 330 from the various input data elements and data variables in PPAH Database Store 307 (340) without additional database searches.

Transformation rules of PPAH Configuration Data Store 404 configured from method step 305 enable software from PPAH Software store 402 to cause the computer 401 to calculate the Key F&O ratios 325 and PPAH 330 using data from existing data stores such as TPM System Information Database 129 and the like, or manually entering input data, or any combination thereof representing a subset of input data expressing transformational rules, such as the actual or estimated PPAH 330 for a customer, market segment, or product group during various time ranges, or other highly complex transformation schemes. Such transformational rules define a manner of collecting, organizing, and integrating the different input data elements to enable computer 401 to relate certain costs (overhead costs), or categories of costs, to certain activities or programs such as but not limited to certain manufacturing centers or selling programs by machine, product, product category, or region, calculate the Key F&O ratios 325 and PPAH 330 under various forecasted or planned circumstances, requests, or other influences, and the like.

In operation, data elements for computing the Key F&O ratios 325 and PPAH 330 are provided to PPAHPS 304 from the Input Data database 306. The data variables from Input Data database 306 are used to populate the PPAH format 700 (see FIG. 7). Computer 401 then runs the PPAHPS 304 software program from PPAH Software Store 402 on the input data variables to compute the Key F&O ratios 325 and PPAH 330. The results are input to the PPAH Database store 307 along with the other data elements of dataset 340 to generate the PPAH formatted dataset 700 similar to the exemplary format shown in FIG. 7. This resulting dataset, formatted as shown in exemplary format 700 is stored in PPAH Database Store 307 where it is accessible to and useful for decision-makers, as well as to TPM System Information Database 129.

Referring to FIG. 3, as an example of PPAH accounting calculations, the cost per unit 320 is the variable unit cost plus the fixed unit cost; profit per unit 321 is the unit revenue minus the unit cost, units per asset-hour 322 is the number of units produced per asset-time, and PPAH 330, as defined above, is calculated for each product based on an asset-time calculation, as is taught, for example, by “throughput accounting.”

Referring to FIGS. 3 and 4, PPAH Format Store 403, PPAH Configuration Data Store 404 and PPAH Software Store 402 are caused to interact with each other and data from Input Data Database 306 whereby computer 401 performs the 310 method step of calculating the Key F&O ratios 325 and PPAH 330 based on PPAH accounting, and displaying the data and calculated Key F&O ratios 325 and PPAH 330 on display device 309 in a format 700 such as that shown in the example of FIG. 7.

The interactive PPAH-formatted dataset 700 enables values of individual cells to be changed (in a “what if” analysis), causing the computer 401 to recalculate the Key F&O ratios 325 and PPAH 330, which, in most cases, will cause the displayed values in other cells to change to reflect the recalculated values.

The typical variables that may be modified via manual intervention for accurately anticipating and forecasting detailed scenarios include, but are not limited to, sales quantities and prices, product costs, business operating expenses, production times and capacity information, and business asset values. Additional quantitative and qualitative information reflecting customer purchases, product volumes, and other transactional information that impact business operations may also be linked to the data inputs within the PPAH formatted dataset 700 to enable decision-makers to understand the factors driving the PPAH of particular transactions, orders, products, customers, and assets.

Thus, the invention enables decision-makers to simulate and forecast various detailed external (marketplace) and internal (workplace) scenarios by modifying any of several data inputs in the integrated PPAH formatted dataset 700 which, when recalculated by method step 310, accurately predicts based on PPAH accounting the financial profit-making impact of current and future conditions and decisions.

PPAHPS 304 provides the decision-maker with the capability to vary each data input element in the PPAH-formatted dataset 700, individually and as a group within the PPAHPS 304 and simulate for the resultant PPAH 330 value. The results of these simulations enable decision-makers to make better informed decisions on the impact these decisions will have on future detailed PPAH 330 and overall ROA 110. The decision-makers are able to get a more accurate view of the impact on profitability by correctly anticipating results and observing the outcomes of changes to one or more variables using PPAHPS 304 as the various data elements are uniquely interdependent and integrated.

Some business choices that can be optimized by a company in a High Mix industry may include but are not limited to: 1) what product mix should decision-makers pursue; 2) which customers, according to profit contribution, should be given greater priority; and 3) how can decision-makers improve profit within the confines of current capacity utilization, including capital expenditure planning related to expansion, or the reduction of physical production capacity through the elimination of facilities. The scenario modeling activity leading to answers to these questions is provided readily by use of PPAHPS 304 in accordance with embodiments of the invention described herein.

In accordance with an embodiment of the invention, advantages of PPAHPS 304, in addition to the capability of extracting profit results, include enabling the user to have control over the following:
Ability to integrate various sources of data into PPAHPS 304. Typical prior art forecasting systems include quantity requirement projections and prices without related time-based cost data for each of the specific products manufactured and without production run time data for specific products at key production steps. PPAHPS 304 has functionality that enables it to be configured with rules that define data value look-ups where there are missing input data values such as costs and production flow rates. Due to this ability of PPAHPS 304 to look-up, calculate, and selectively input detailed cost and production flow rate modifications or additions to each line item, the user is able to calculate the profitability of forecasted line items results by PPAH 330 and assess their PPAH ranking even when some input data values are missing.
PPAHPS 304 provides information and data that enables decision-makers to anticipate future ROA 110 by providing the ability to simulate various scenarios, but is not limited to such scenarios. PPAHPS 304 allows decision-makers to modify any one or several data input elements or data variables such as but not limited to quantity, price, cost, production flow rate, and equipment capacity changes, that may impact the profitability of any forecast. PPAHPS 304 gives decision-makers the ability to estimate future data values to assess the impact of future events on ROA, thereby providing the decision-makers the opportunity to achieve the profit improvement results.
PPAHPS 304 allows the decision-makers to make adjustments or edits to the input data elements or data variables at any level of aggregation/disaggregation with the capability of assessing the impact of those adjustments across available and pending sales orders ranked by PPAH. This assessment of impact provides decision-makers the opportunity to change the parameters of incoming sales orders in order to improve ROA 110.

It will be obvious to those skilled in the art that not all possible sets of components of PPAH 330 are shown in the exemplary dataset 700. The exemplary sets of components 700 that are shown provide an understanding of the invention and detail of extraction and compilation of PPAH information using the invention in accordance with an embodiment.

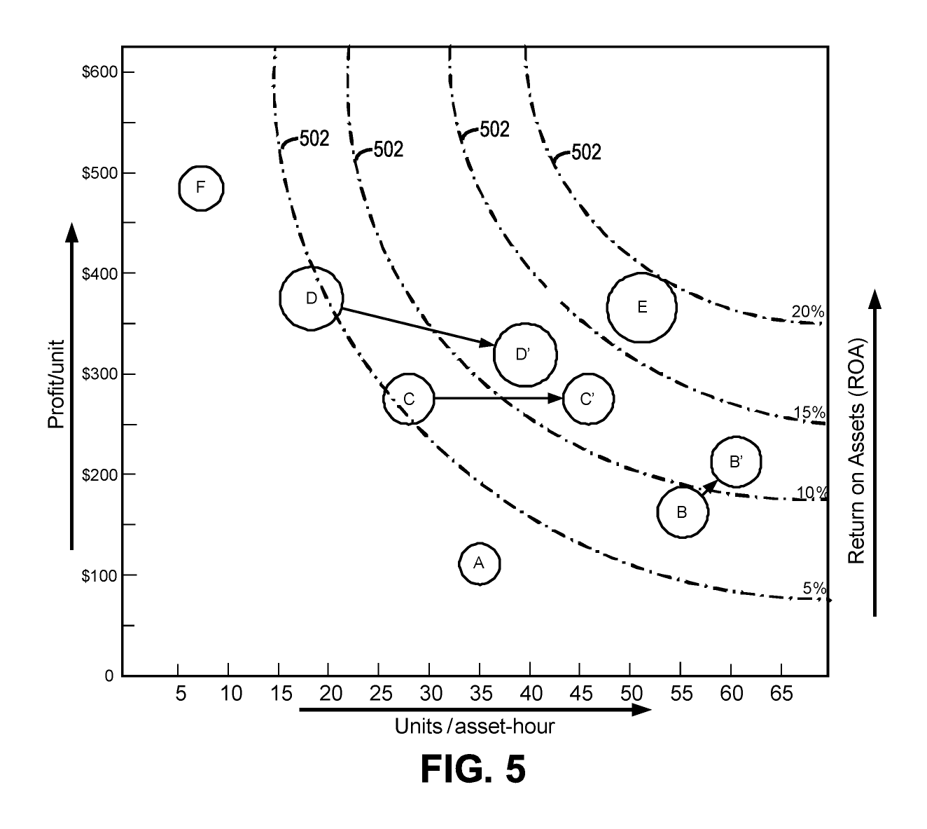

FIG. 5 is an exemplary and non-limiting graph that locates a plurality of products A-F of a company's manufacturing line relative to their individual PPAH 330. The left vertical axis represents profit per unit (margin) 113 (FIG. 1) and the lower horizontal axis represents units per asset-hour 322 (FIG. 2). The components of profit per asset-hour 330 for any given product are the two coordinates that locate the product on the graph. Each broken-line contour curve 502 represents all combinations of profit/unit and units per asset-hour that equal one value of profit per asset-hour 330. Each of these contour curves 502 and profit per asset-hour values also reflect an ROA % based on the value of the asset base applicable to that set of data depicted in the chart and calculated using the transformational rules. The broken-line contour curves 502 are a plot of aggregate ROA levels expressed as a percent. By plotting the PPAH of a product, it can be immediately seen if that product will meet an ROA target set by the company. For the different products A-F shown, the invention provides decision-makers the ability to understand and adjust the component variables which describe the character of the associated products, orders, manufacturing assets, prices, and the like, which influence their financial return generated ROA. For example, products A, B, C, D, and F display a profit per asset-hour ratio that does not represent achieving, for example, a 10% targeted ROA, inasmuch as they reside below the 10% ROA threshold curve 502.

However, under traditional unit and margin accounting analysis, decision-makers would errantly perceive products C, D and F as more significant contributors to ROA because they display significant unit margin. Products A and B, by example, present significant unit velocity, but lower unit margin, while products C, D, and F, by example, present higher unit margin but lower unit velocity. Unless decision-makers have integrated and combined access to margin 113 and UPAH 322, trade-off sensitivities (position relative to a curve 502) for each product, they will be unable to accurately anticipate the results of different potential futures, make decisions, and take initiatives to move products, orders, and customers toward higher levels of ROA, as depicted by the combination higher margin and UPAH products, in the case of product E, which resides above the 15% ROA curve. Products B, C, and D are shown as having alternate positions B′, C′, and D′ (all above the 10% curve) to illustrate the possibility of moving these products into a higher ROA level by modifying one or more of the variables (see FIG. 7) that determine their PPAH 330.

A person skilled in the art would readily appreciate that the invention disclosed herein is described with respect to specific embodiments that are exemplary. However, this should not be considered a limitation on the scope of the invention. Specifically, other implementations of the disclosed invention are envisioned and hence the invention should not be considered to be limited to the specific embodiments discussed herein above. Embodiments may be implemented on other computing-capable systems and processors or a combination of the above. Embodiments may also be implemented as a software program stored in a memory module to be run on an embedded, standalone or distributed processor, or processing system. Embodiments may also be run on a processor, a combination of integrated software and hardware, or as an emulation on hardware on a server, a desktop, or a mobile computing device. The invention should not be considered as being limited in scope based on specific implementation details, but should be considered on the basis of current and future envisioned implementation capabilities.

In another embodiment, the results of the calculations in method step 310 (FIG. 3) are provided to TPM System 120 (FIG. 1B), enabling the operations controlled by the TPM System Output 127 to use the Key F&O ratio values 325. Thus, for example, TPM System Information Database 129 may include costs per unit and profit per unit that are initially calculated by the prior art system using traditional units-based accounting, as described in the Background section above. One embodiment of the present invention replaces (overrides) the prior art calculated values costs per unit, and profit per unit with asset-time-based costs per unit values 320 and profit per unit values 321, as described herein above. The substitution of unit based values with asset-time-based values allows TPM System 120 to operate with the asset-time-based numbers, thus allowing the TPM System 120 to operate on an ROA 110 basis. Thus, for example, if the TPM System 120 is an MES system, a factory may be operated by TPM System 120 to maximize ROA based on the asset-time-based calculated values described herein.

Thus, for example, TPM System 120 may be operated to generate TPM Systems Database 129. Referring to FIG. 3, System 300 extracts information from TPM Systems Database 129 into TPM Systems Input Database 306 and generates costs per unit 320, profits per unit 321, and units per asset-hour 322, calculated by method 310. The values of costs per unit 320, profit per unit 321, and units per asset-hour 322 are then provided back to TPM Systems Store 129, replacing and overriding unit-based accounting values that were originally calculated by TPM System 120. TPM System 120 will then operate using the time-based values, and thereby operate the TPM System to maximize ROA.

The Gain (Loss) calculation of Gross Cash Contribution Margin (Profit) is a primary measure of a business's operational effectiveness. The value of Gross Cash Contribution Margin (Profit/Loss) is comprised of a plurality of financial and operational ratios (“Gain Attributes”) having calculable values from their components which values in the prior art are arrived at using unit-based accounting only.

In the present invention, in addition to calculating the values of such Gain Attributes and their components using unit-based accounting, they are also calculated using asset-time-based accounting (PPAH accounting) producing values which, when converted back to unit-based accounting values for comparative purposes, will typically produce different ratios and component values. In other embodiments, additional information may be calculated by method 310 and stored in PPAH Database Store 307 from which they can be displayed by method step 308 in a useful, interactive format on a display device 309 (such as that illustrated in FIG. 7), as described above.

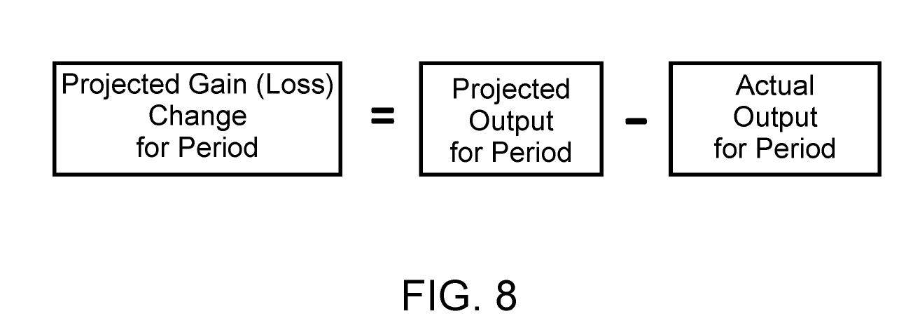

In certain embodiments, a “Gain Attribute” is calculated to capture changes in financial outcomes of varied business scenarios demonstrating the comparative impacts of actual and projected management decisions utilizing PPAH accounting. In one embodiment, the Gain Attributes, including, but not limited to, any of the Gain Attributes described herein, are calculated by method 310 and stored as Gain Attribute 332 in PPAH Database 340. The change of the attributes is measured utilizing detailed transaction data from a base set of data which reflects real business alternatives before any changes were implemented. The Gain period data must be of a comparable duration and seasonal base. FIG. 8 is a diagram that depicts the formula for Gain (Loss) over time. Projected Gain (Loss) Change for Period=Projected Output for Period—Actual Output for Period.

A gain value related to a particular attribute in a business scenario that reaches a specified threshold triggers defined actions in other systems, such as pricing, selling, purchasing, scheduling, and producing, with the objective of realizing a desired positive business impact, as measured by increases in return on assets (ROA).

As in every other aspect of business accounting, while developing a rigorous and reliable method for calculating Gain, one must establish clear, straightforward rules and definitions. If those rules and definitions are followed, an accurate accounting of Gain will result. The rules for calculating Gain are as follows:
Only transaction level source data is sufficiently detailed to allow an accurate calculation of the Gain effect;
Transactional data must be grouped (or ‘rolled up’) in a manner that reflects real business alternatives that, if chosen, would change the value of the Gain; and
Comparable time periods for datasets must be used when calculating Gain.

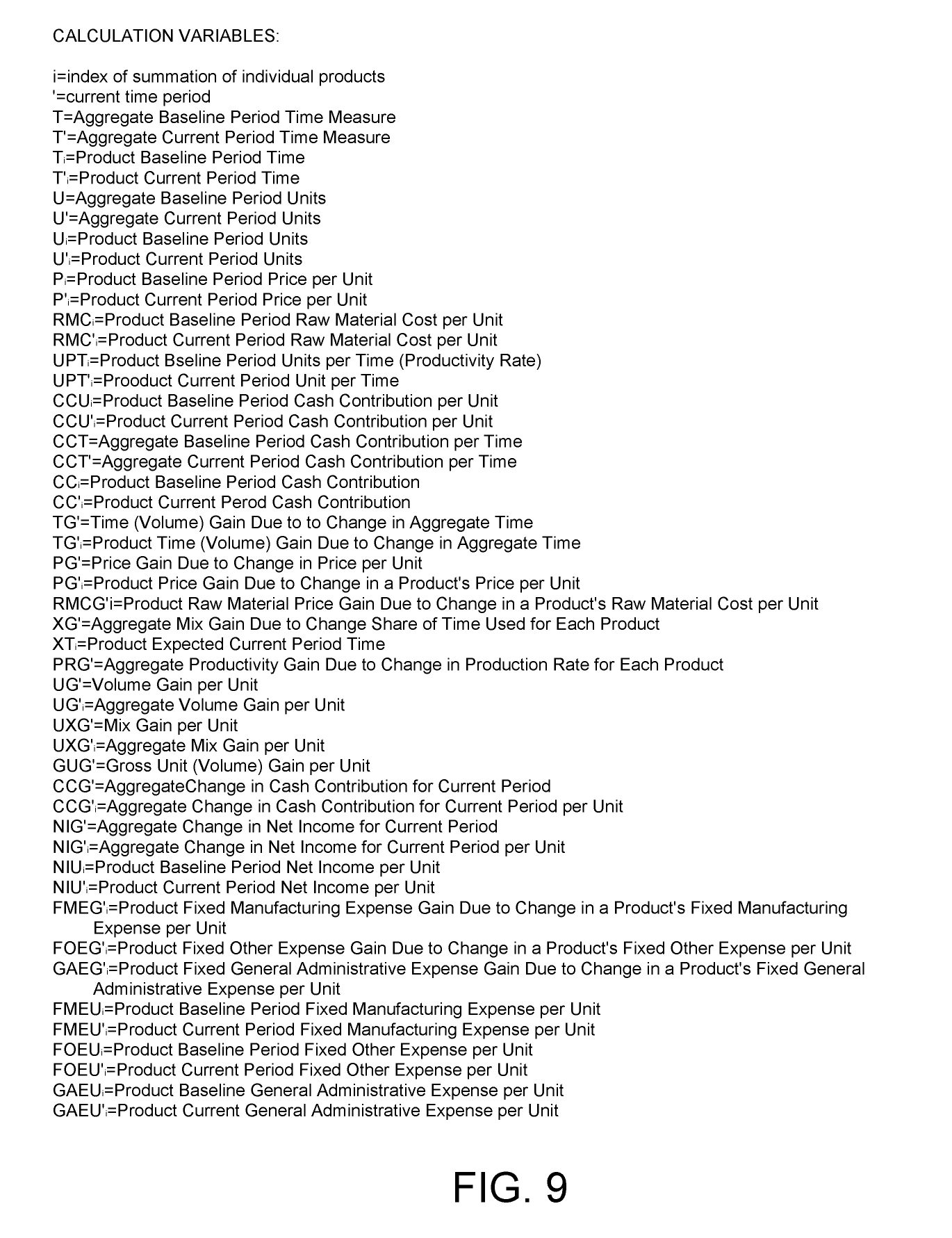

The definitions governed by the rules as presented reflect the equations, and variables for determining Gain are shown in the Table of FIG. 9 which describes variables and formulas for calculating different types of Gain in a business. It should be noted the different Gain variables and formulas included in this document use notation which use two general standards. First, the use of the character “i” is used to refer to an individual product, such that if a dataset consists of 1,000 different products, then the text i=1 to n″ means “i” will have values from 1 to 1,000 where each number represents a specific product and the associated variable represents the data for that product. Second, the formulas and definitions distinguish data which represent two different time periods, baseline and current. In the formulas and variables, data representing the current time period is denoted using the mark ′, commonly called an apostrophe. Data representing baseline time period has no mark.

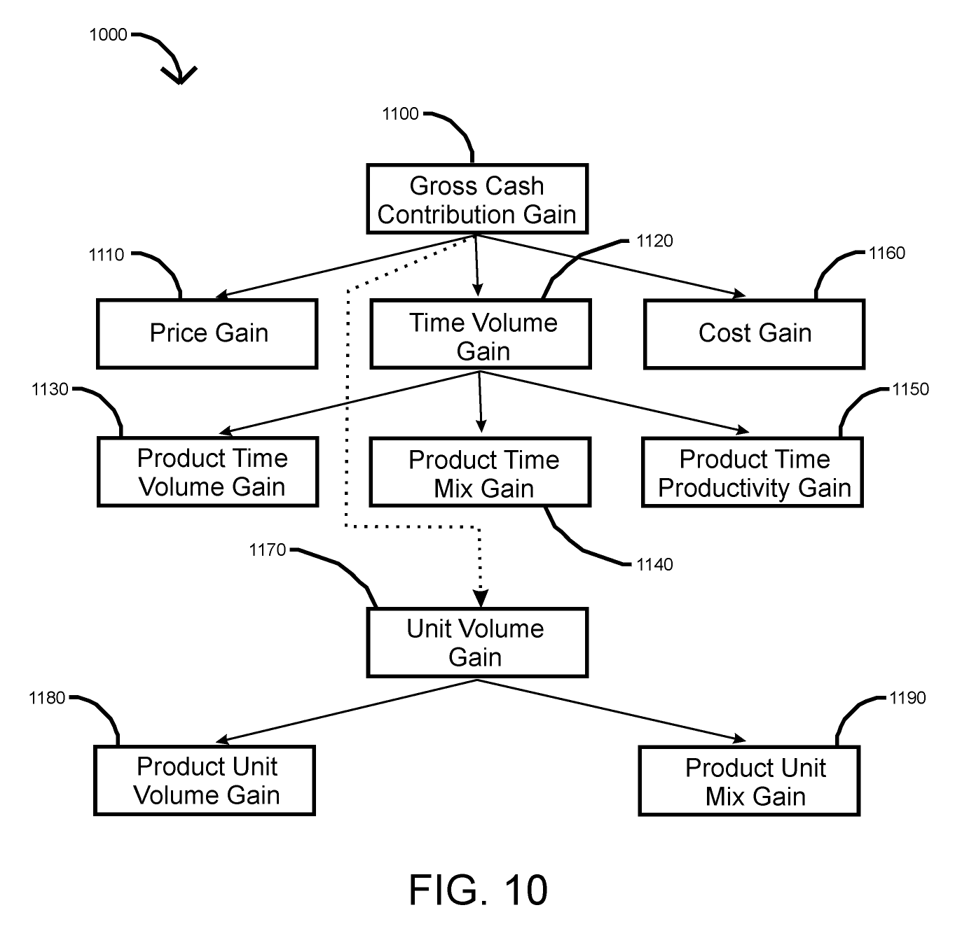

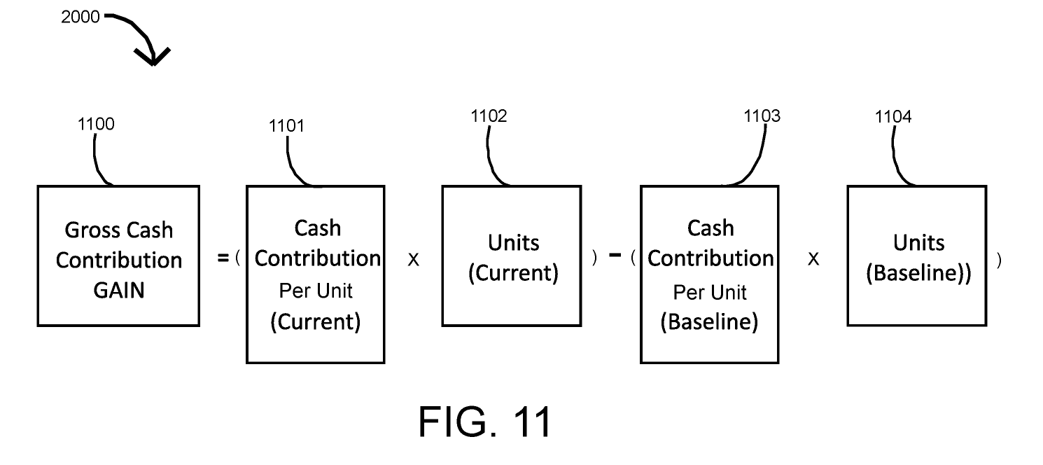

A multi-step method is illustrated in FIG. 10 as a schematic 1000, with additional detail in FIGS. 11-20. Schematic 1000 depicts the hierarchical relationship of Gross Cash Contribution Gain 1100 to its components Price Gain 1110, Time Volume Gain 1120, and Cost Gain 1160, and the Time Volume Gain 1120 to its components Product Time Volume Gain 1130, Product Time Mix Gain 1140, Product Time Productivity Gain 1150; and Unit Volume Gain 1170 to its components Product Unit Volume Gain 1180 and Product Unit Mix Gain 1190.

Cash Contribution is the difference between product revenue and direct variable cost. Cash Contribution Gain 1100 is the sum of Price Gain 1110, Cost Gain 1160, and Volume Gain 1120 between the base and current or gain periods. Specifically, Product Time Mix Gain 1040 is the measure of changed profitability obtained by the business derived from purposely making adjustment to its sales when informed by the PPAH 330. Product Time Productivity Gain 1150 is the measure of changed profitability obtained by the business derived from changes in the rate at which each product moves through the critical assets when informed by the PPAH 330. Product Time Volume Gain 1130 is the measure of changed profitability obtained by the business derived from the sum of each product's change in volume attributable to the general or gross change in volume for all products together when informed by the PPAH 330.

Together, Product Time Volume Gain 1130, Product Time Productivity Gain 1150, and Product Time Mix Gain 1140 add up to the Time Volume Gain 1120.

Cost Gain 1160 is the measure of changed profitability obtained by the business derived from raw material cost changes to the products during the current time period as compared to raw material cost recorded in the baseline period. Price Gain 1110 is the measure of changed profitability obtained by the business derived from price changes to the products during the current time period as compared to prices recorded in the baseline period.

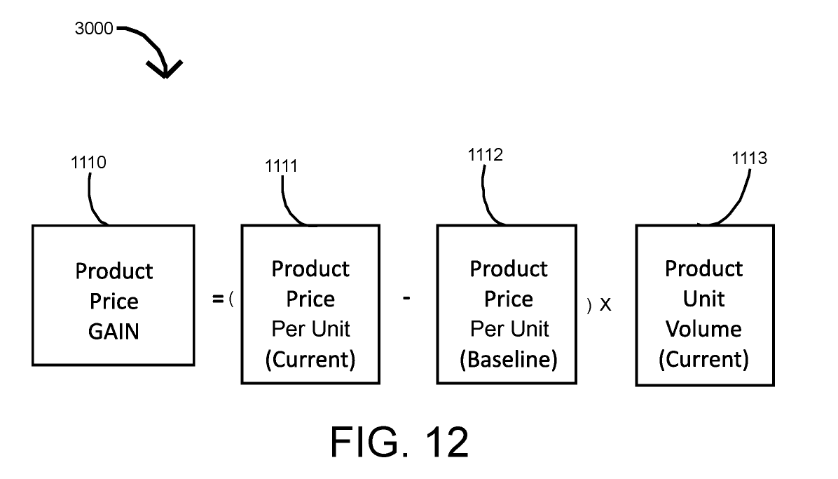

The method illustrated in schematic 2000 (FIG. 11) describes how Gross Cash Contribution Gain 1100 is computed. FIGS. 12-20 illustrate how the components Price Gain 1110, Cost Gain 1160, Time Volume Gain 1120, Product Time Volume Gain 1130, Product Time Mix Gain 1140, Product Time Productivity Gain 1150, Gross Units Gain 1170, Product Unit Volume Gain 1180 and Product Mix Gain 1190 are calculated.

The method further computes the components of Time Volume Gain 1120, as Product Time Volume Gain 1130, Product Time Productivity Gain 1150, and Product Time Mix Gain 1140, specifically with the time metric PPAH 330. Additionally, it computes Unit Volume Gain 1170, based upon units, rather than time (PPAH), including its two components, Product Unit Volume Gain 1180, and Product Unit Mix Gain 1190.

Schematic 2000 thus describes the calculation of Gross Cash Contribution Gain in the multi-step method and is intended to describe changed profitability informed by the metric PPAH. The change is measured from a base set of data that reflects the business before any changes were implemented. When measuring the change from the base, the gain period data is comparable in time duration and seasonal effect to the base. The change attributable to each component is a function of the changes inherent in the variable driving each of those components.

First, shown in FIG. 11 as a diagram 2000, the Gross Cash Contribution Gain 1100 is calculated. Gross Cash Contribution Gain 1100 is obtained by subtracting the “Baseline Cash Contribution (1103) per unit multiplied by the Baseline Units (1104)” from “Current Period Cash Contribution (1101) per unit multiplied by the Current Units (1102).” Furthermore, Gross Cash Contribution Gain 1100 is also obtained by adding Price Gain (1110), Volume Gain (1120), and Cost Gain (1160).

The Baseline Cash Contribution represents the cash contribution generated by products sold during the time range before changes had been implemented. By deducting Baseline Cash Contribution (1103) per unit multiplied by the Baseline Units (1104) from Current Period Cash Contribution (1101) per unit multiplied by the Current Units (1102) to compute Gross Cash Gain (1100), the method isolates the total change in cash contribution during the period that was caused by some combination of price, cost, volume, productivity and mix changes.

The Gross Cash Contribution Gain, or Aggregate Change in Gross Cash Contribution, is calculated by summing the changes in Cash Contribution for each product. Each product's Gross Cash Contribution (CCG′(i)) is calculated for the Baseline and Current Periods by multiplying the product's Cash Contribution per Unit, or Price per unit (P(i)) minus its Raw Material Cost (RMC(i)) per unit, CCU(i)=P(i)−RMC(i), by the number of product Units (U(i)) for the respective periods. The individual product calculations are:

CCG′(i)=(CCU′(i)*U′(i))−(CCU(i)*U(i)), and

the aggregate for all products is calculated as:

$${\sum }_{i = 1}^{n} {CCG}^{′} ( i ) = ( {CCU}^{′} ( 1 ) * {U}^{′} ( 1 ) ) - ( CCU ( 1 ) * U ( 1 ) ) + ( {CCU}^{′} ( 2 ) * {U}^{′} ( 2 ) ) - ( CCU ( 2 ) * U ( 2 ) ) + … + ( {CCU}^{′} ( n ) * {U}^{′} ( n ) ) - ( CCU ( n ) * U ( n ) )$$

Or, alternately,

$$Total {CCG}^{′} = {\sum }_{i = 1}^{n} {PG}^{′} ( i ) + {\sum }_{i = 1}^{n} {RMCG}^{′} ( i ) + {\sum }_{i = 1}^{n} {TG}^{′} ( i ) + {\sum }_{i = 1}^{n} {PRG}^{′} ( i ) + {\sum }_{i = 1}^{n} {XG}^{′} ( i )$$

Next, shown in FIG. 12 as a diagram 3000, the formula for Product Price Gain is calculated. Each product code in the product database is analyzed by comparing every single sales transaction for that product. All sales prices during the current time period (1111) are compared to sales prices in the baseline period (1112) for that product. Price changes are multiplied by the current period's quantity, Product Unit Volume (Current) (1113), to derive the price gain for each transaction. All the transactional price gains are added together to compute the total Price Gain (1110) for the product. Continuing, all Price Gain values for all the products in the product database are added together to compute the total Product Price Gain (1110). It is possible for negative price changes, or price declines, resulting in negative Price Gains.

The Product Price Gain (PG′(i)) is calculated individually for each product and then aggregated. The change in the product's price per unit is calculated by subtracting the product's Baseline Price per Unit (P(i)) from the product's Current Price per Unit (P′(i)) and then multiplying it by the product's Current Period Unit Volume (U′(i)).

The individual product's Price Gain is calculated as follows:

PG′(i)=(P′(i)=P(i))*U′(i),

and the aggregate for all products is calculated as:

$${\sum }_{i = 1}^{n} {PG}^{′} ( i ) = ( {P}^{′} ( 1 ) - P ( 1 ) ) * {U}^{′} ( 1 ) + ( {P}^{′} ( 2 ) - P ( 2 ) * {U}^{′} ( 2 ) + … + ( {P}^{′} ( n ) - P ( n ) ) * {U}^{′} ( n )$$

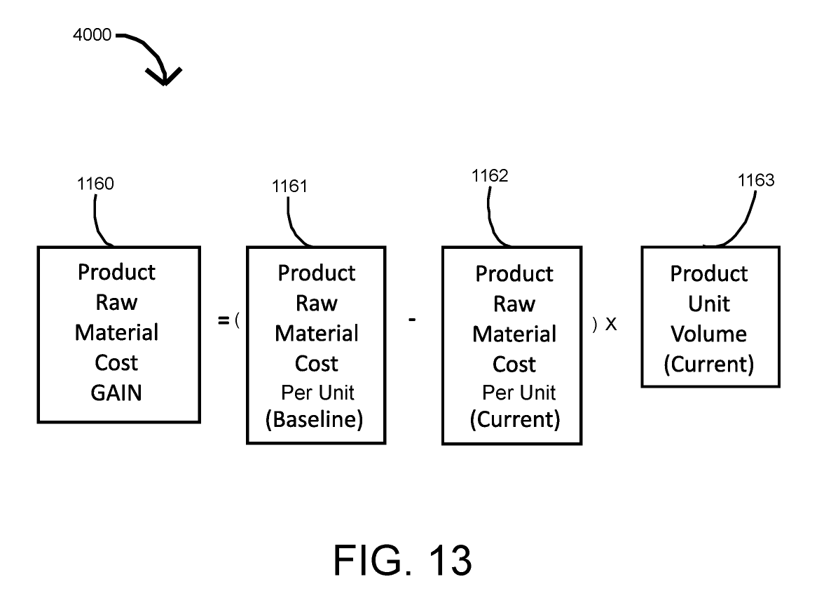

Next, shown in FIG. 13 as diagram 4000, the Product Raw Material Cost Gain 1160 is calculated. This is done by analyzing each product in the product database and comparing every single sales transaction for that product. Unlike with product prices, declines in material costs cause increases in cash contribution, while increases in costs will reduce cash contribution. All material costs during the current time period, Product Raw Material Cost per unit (Current) 1162, are subtracted from the material costs recorded in the baseline period for that product, Raw Material Costs per unit (Baseline) 1161, and multiplied by the current period's quantity, Product Unit Volume (Current) 1163, to derive the Product Raw Material Costs Gain 1160 for each transaction. All the transactional raw material cost gains are added together to compute the total Product Raw Material Cost Gain 1160 for the product. Continuing, all Raw Material Cost gain values for all the products in the product database are added together to compute the total Product Raw Material Cost Gain 1160.

The Product Raw Material Cost Gain (RMCG′) is calculated individually for each product by subtracting the Product Raw Material Cost in the Current period (RMC′(i)) from the Product Raw Material Cost in the Baseline period (RMC(i)) and then multiplying the change by the product's Current Period Unit Volume (U′(i)).

It is noted that Raw Material Cost changes are handled differently than Price changes since the Gain impact of cost changes are the opposite of Price changes.

The individual product calculation is:

RMCG′(i)=(RMC(i)−RMC′(i)*U′(i), and

the aggregate value for all products is calculated as:

$${\sum }_{i = 1}^{n} {RMCG}^{′} ( i ) = ( RMC ( 1 ) - {RMC}^{′} ( 1 ) ) * {U}^{′} ( 1 ) + ( RMC ( 2 ) - {RMC}^{′} ( 2 ) ) * {U}^{′} ( 2 ) + … + ( RMC ( n ) - {RMC}^{′} ( n ) ) * {U}^{′} ( n ) .$$

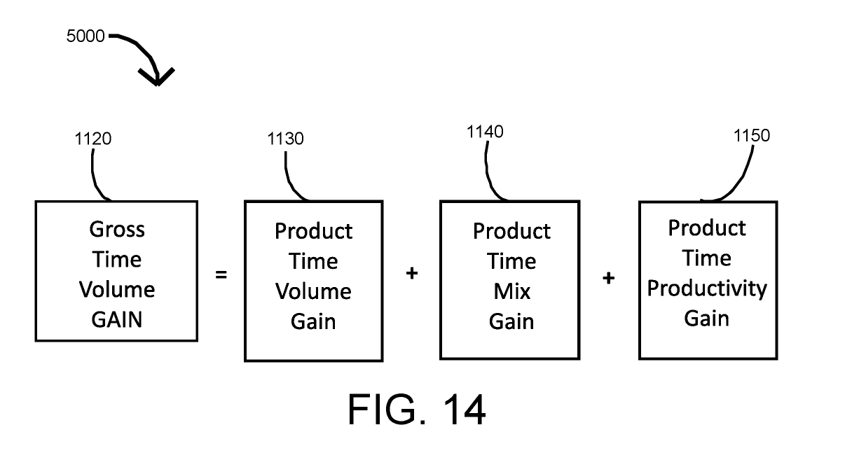

Next, the Gross Time Volume Gain (GTG) is calculated, as indicated in FIG. 14, as a diagram 5000. The Gross Time Volume Gain 1120 is comprised of a general Product Time Volume Gain (TG) 1130, a Product Time Mix Volume Gain (XG) 1140 and a Product Time Productivity Gain (PRG) 1150, and is calculated from: GTG′=TG′+XG′+PRG′.

The general Time Volume Gain is based on the assumption that products' shares of the total Volume remain the same from the Baseline to the Current Time Period, i.e. each product's share of the total mix stays the same. These volume increases reflect a general increase or decrease in volume across all products, for example, due to an enlargement or decline of the total market. The Time Mix Gain is based on the assumption that changes in products' shares of the total volume from the Baseline to the Current Time Period reflect a mix change and are thereby distinguished from the volume change.

Next, the Gross Time Volume Gain 1120 is calculated. Gross Time Volume Gain 1120 in its simplest form is the change in volume from the baseline period valued by the baseline cash contribution (difference between price and material cost). As volume changes from one period to the next, there is a change in cash contribution directly attributable to the change in volume. To derive PPAH, the Gross Time Volume Gain 1120 is calculated based upon the volume of production time (hour or minutes) of the manufacturing asset and is comprised of three components: Time Product Volume Gain 1130, Time Productivity Gain 1150, and Time Mix Gain 1140.

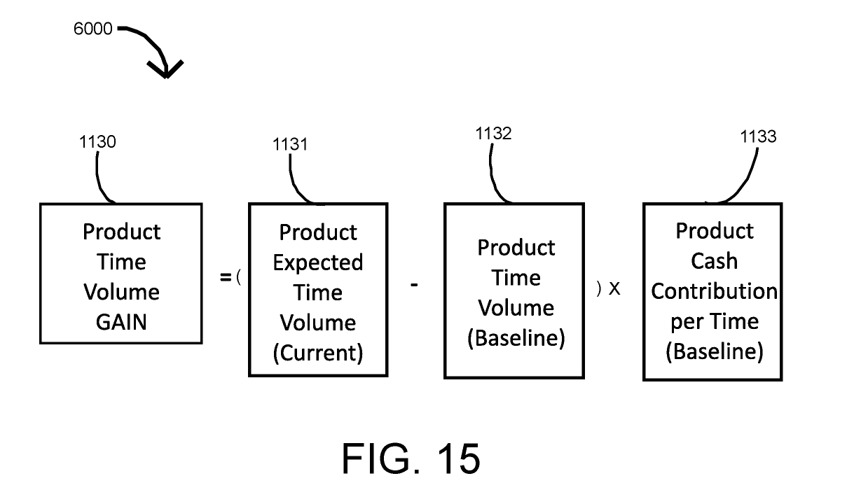

Each product's Time Volume Gain (TG′(i)) 1130, illustrated in FIG. 15 as a diagram 6000, can be calculated by subtracting the product's manufacturing time volume (in hours or minutes) in the Baseline time period, Product Time Volume Baseline (T(i)) 1132, from the product's expected manufacturing time volume (in hours or minutes) in the Current time period, Product Expected Time Volume Current (ET′(i)) 1131 and then multiplying that difference in time volume by the product's average cash contribution per unit of time during the Baseline time period, Baseline Cash Contribution per Time (CCT(i)) 1133. The product's manufacturing time volume in the Baseline period is the sum of the asset manufacturing time for the product during the Baseline time period. The product's expected manufacturing time volume in the Current time period is derived by taking the sum of all products asset manufacturing time during the Current time period (T′) and multiplying it by the product's Baseline time period share of the total asset manufacturing time in the Baseline time period (T(i)/T) such as: ET′(i)=T′*T(i)/T. The product's Baseline Cash Contribution per Time (CCT(i)) is the sum of the product's cash contribution during the Baseline time period divided by the sum of the product's asset manufacturing time during the Baseline time period. The individual product calculation is:

TG′(i)=(ET′(i)−T(i))*CCT(i), and

the aggregate value for all products is:

$${\sum }_{i = 1}^{n} {TG}^{′} ( i ) = ( {ET}^{′} ( 1 ) - T ( 1 ) ) * CCT ( 1 ) + ( {ET}^{′} ( 2 ) - T ( 2 ) ) * CCT ( 2 ) + … + ( {ET}^{′} ( n ) - T ( n ) ) * CCT ( n )$$

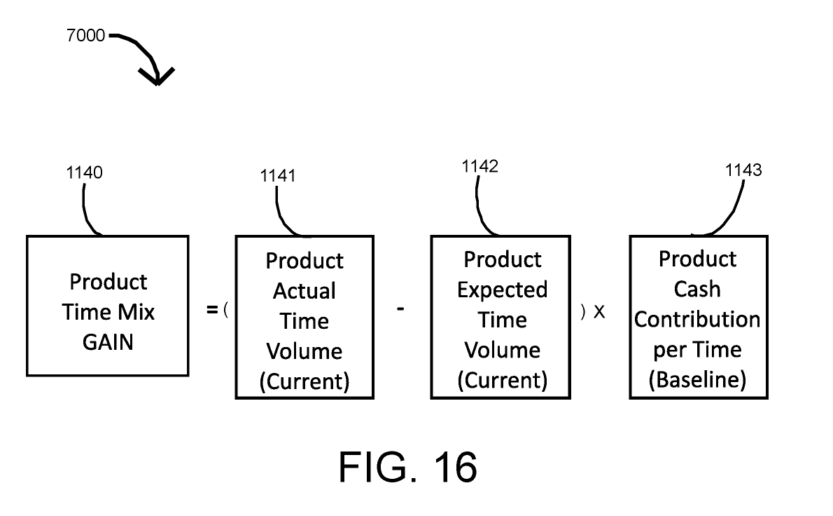

Next, the Product Time Mix Gain (1140) is calculated based on production time, shown in FIG. 16 as a diagram 7000. Product Time Mix Gain (1140) is defined as the cash contribution value arising from an increase or decrease in relative share of a product's time volume. Product Time Mix Gain (XG′(i)) 1140 is the sum of each product's Time Mix Gain, expressed as Product Expected Time Volume (Current) 1142 subtracted from Product Actual Time Volume (Current) 1141 multiplied by Product Cash Contribution per Time (Baseline) 1143. The time mix share of each product is calculated for the baseline period, T(i)/T. The expected mix share is then determined for the current period volume by multiplying the baseline share by the current period time volume of all products (T′), ET′(i)=T′*T(i)/T. The difference between the product's current period expected time volume (ET′(i)) and its current period actual time volume (T′(i)) is the volume attributable to mix gain. To value the mix gain time volume, the Baseline Period cash contribution per production time for the product, CCT(i), is used.

The cash contribution impact of shifting time to or away from a product is measured as the difference between the actual and expected time volume multiplied by the Baseline Product Cash Contribution per Time. The baseline values are used in this calculation because the Price and Raw Material Cost Gain calculations already measured all gains due to changes in each product's Cash Contribution per Time from Baseline to Current Period. The individual product is calculated as: XG′(i)=(T′(i)−ET′(i))*CCT(i), and the aggregate for all products is calculated as:

$${\sum }_{i = 1}^{n} {XG}^{′} ( i ) = ( {T}^{′} ( 1 ) - {ET}^{′} ( 1 ) ) * CCT ( 1 ) + ( {T}^{′} ( 2 ) - {ET}^{′} ( 2 ) ) * CCT ( 2 ) + … + ( {T}^{′} ( n ) - {ET}^{′} ( n ) ) * CCT ( n )$$

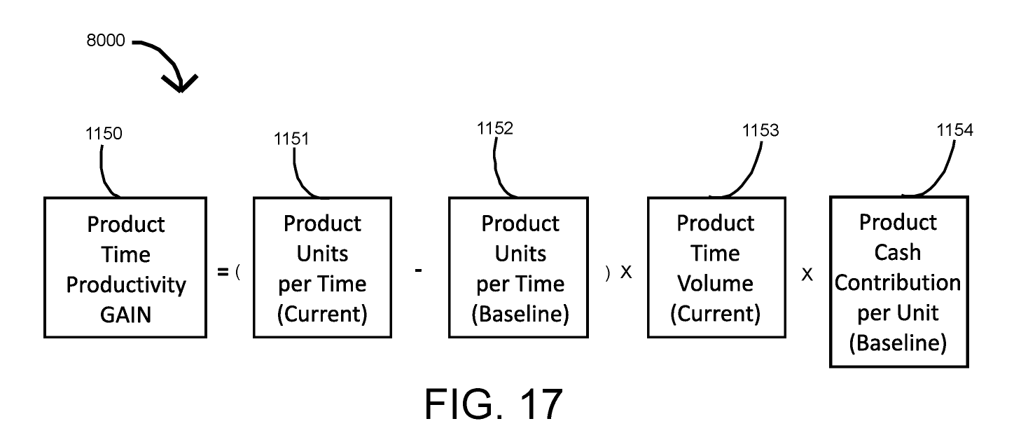

Next, the Product Time Productivity Gain 1150 based on production time is calculated, shown in FIG. 17, as a diagram 8000. Changes in the rate at which each product moves through the critical production assets will impact the amount of time used in the metric Profit Per Asset Hour (PPAH) 330. If Time Mix or Time Mix Gain is calculated using production time, it is possible that changes in productivity, the amount of asset manufacturing time per unit of output, could cause increases or decreases in time mix share. Therefore, it is necessary to account separately for the impact of such productivity changes on the total change in a product's Cash Contribution. This is done by valuing the amount of asset manufacturing time in the current period that is attributable to productivity changes by multiplying the change in productivity by the product's Current Period time volume and by the Baseline Cash Contribution per Unit. Product Time Productivity Gain (PRG′(i)) 1150 is obtained by subtracting Product Units per Time (Baseline) 1152 from Product Units per Time (Current) 1151, and then multiplying the result by Current Product Time Volume 1153 and Product Cash Contribution per Unit (Baseline) 1154.

When calculating gain using the production time, the impact on Aggregate Cash Contribution resulting from changes in the production rate for each product must be taken into account. Change in Cash Contribution due to Productivity Gain is calculated for each product and aggregated, as follows:

UPT(i)=Product Baseline Period Units per Time (Productivity Rate);

UPT′(i)=Product Current Period Units per Time (Productivity Rate); and

PRG′(i)=Aggregate Productivity Gain.

The individual product's Time Productivity Gain is calculated from:

PRG′(i)=(UPT′(i)−UPT(i))*T′(i)*CCU(i),

and the aggregate for all products is calculated from:

$${\sum }_{i = 1}^{n} {PRG}^{′} ( i ) = ( {UPT}^{′} ( 1 ) - UPT ( 1 ) ) * {T}^{′} ( 1 ) * CCU ( 1 ) + ( {UPT}^{′} ( 2 ) - UPT ( 2 ) ) * {T}^{′} ( 2 ) * CCU ( 2 ) + … + ( {UPT}^{′} ( n ) - UPT ( n ) ) * {T}^{′} ( n ) * CCU ( n )$$

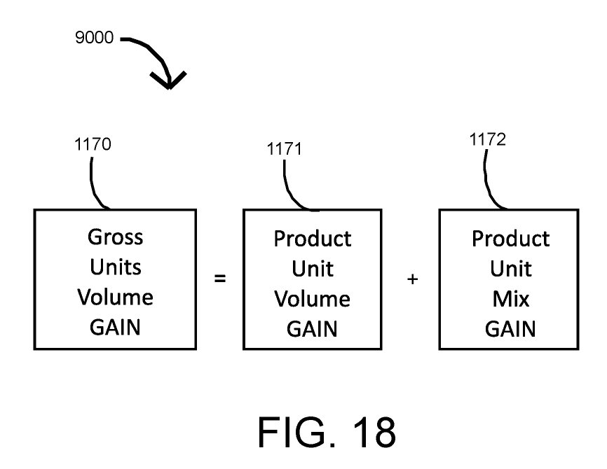

The next method is to calculate the Gross Units Volume Gain (GUG′) 1170 utilizing unit quantity, rather than time volume, shown in FIG. 18 as a diagram 9000. Gross Units Volume Gain 1170 is obtained by adding Product Unit Mix Gain 1172 to Product Unit Volume Gain 1171. When using product Units instead of time, the Volume and Mix Gain valuations are calculated differently from the time-based calculations. The unit-based volume gain calculation is simpler than the time-based measure and does not need to calculate a Productivity Gain since changes in production rate are not considered.

The Gross Units Volume Gain is comprised of two values, the product's general Unit Volume Gain and Unit Mix Gain: GUG′(i)=UG′(i)+UXG′(i), and the total is:

$${GUG}^{′} = {\sum }_{i = 1}^{n} {UG}^{′} ( i ) + {\sum }_{i = 1}^{n} {UXG}^{′} ( i )$$

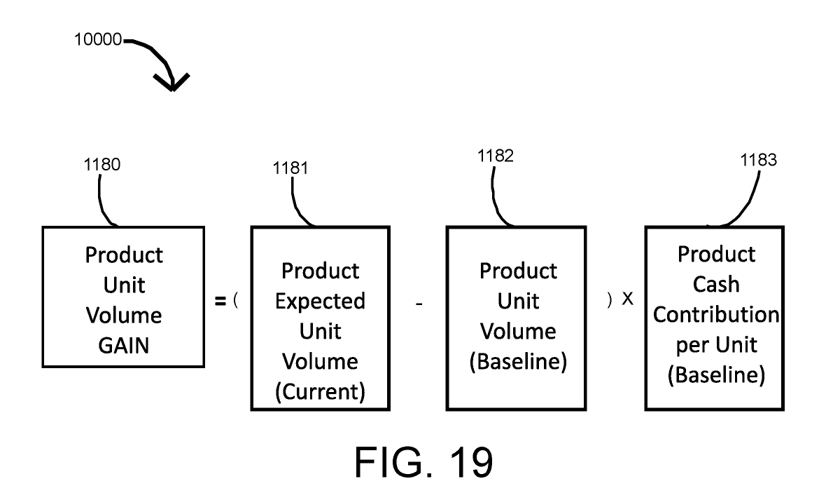

Next, the Product Unit Volume Gain 1180 is calculated, shown in FIG. 19 as diagram 10000. Product Unit Volume Gain 1180 is obtained by subtracting Product Unit Volume (Baseline) 1182 from Product Expected Unit Volume (Current) 1181, and multiplying by Product Cash Contribution per Unit (Baseline) 1183. Product Unit Volume Gain 1180 is the sum of each product's change in volume attributable to the general change in volume for all products together. The Volume Gain is valued at the rate of the product's Baseline Cash Contribution.

The Product Units Volume Gain (UG′(i)) is calculated by first subtracting the product's unit volume in the Baseline time period (U(i)) from its expected unit volume in the Current time period (EU′(i)) and then valuing those units at the rate of the product's Cash Contribution per Unit in the Baseline time period, Baseline Cash Contribution per Unit (CCU(i)). The individual product Unit Volume Gain is calculated from:

UG′(i)=(EU′(i)−U(i))*CCU(i) and

the aggregate value for all products is calculated from:

$${\sum }_{i = 1}^{n} {UG}^{′} ( i ) = ( {EU}^{′} ( 1 ) - U ( 1 ) ) * CCU ( 1 ) + ( {EU}^{′} ( 2 ) - U ( 2 ) ) * CCU ( 2 ) + … + ( {EU}^{′} ( n ) - U ( n ) ) * CCU ( n )$$

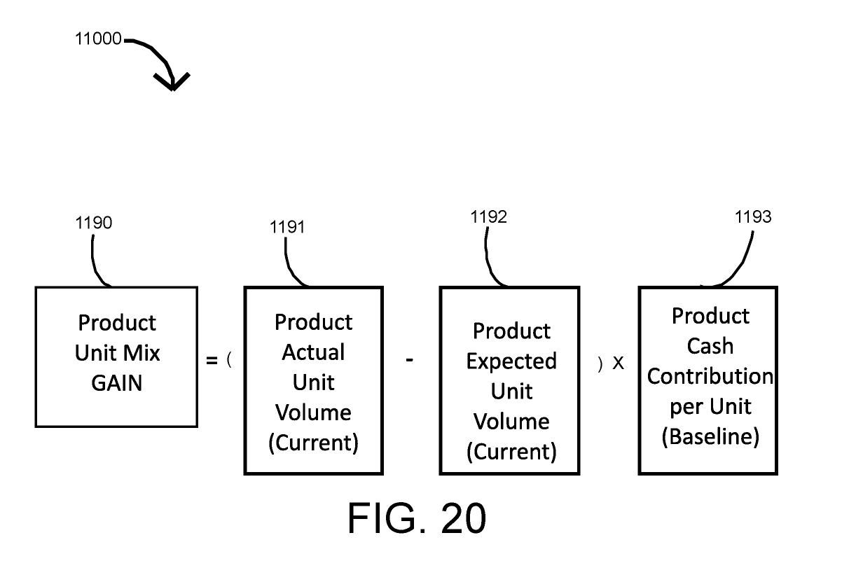

The last step is to calculate the Product Unit Mix Gain 1190, shown in FIG. 20 as a diagram 11000. The Product Unit Mix Gain 1190 is calculated by first subtracting the product's Expected Unit Volume (Current) 1192 from product's Actual Unit Volume (Current) 1191, and then multiplying those units by the product's Cash Contribution per Unit (Baseline) 1193. Product Unit Mix Gain 1190 is defined as the cash contribution value arising from an increase or decrease in relative unit volume share of a product. Product Unit Mix Gain is the sum of each product's change in volume, negative or positive, attributable to changes in mix share of the Gross Unit Volume Gain. The baseline unit share of each product is calculated for the Baseline time period by dividing the product's baseline unit volume by the baseline unit volume of all products (U(i)/U). The product's expected unit volume (EU′(i)) is then determined for the current period by multiplying the baseline share by the current period unit volume of all products, EU′(i)=U′*(U(i)/U). The difference between the product's current period expected volume (EU′(i)) and its current period actual volume (U′(i)) is the volume attributable to mix gain. To value the mix gain volume, the product's Baseline Period cash contribution per unit, CCU(i), is used. Each product's Unit Mix Gain is calculated as:

UXG′(i)=(U′(i)−EU′(i)*CCU(i).

The aggregate Unit Mix Gain for all products is calculated as:

$${\sum }_{i = 1}^{n} {UXG}^{′} ( i ) = ( {U}^{′} ( 1 ) - {EU}^{′} ( 1 ) ) * CCU ( 1 ) + ( {U}^{′} ( 2 ) - {EU}^{′} ( 2 ) ) * CCU ( 2 ) + ( {U}^{′} ( n ) - {EU}^{′} ( n ) ) * CCU ( n )$$

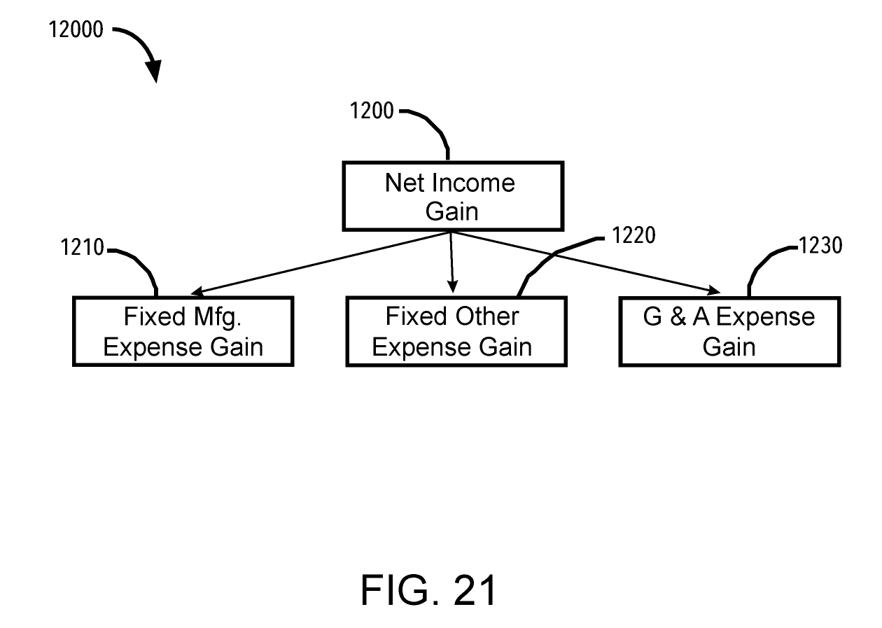

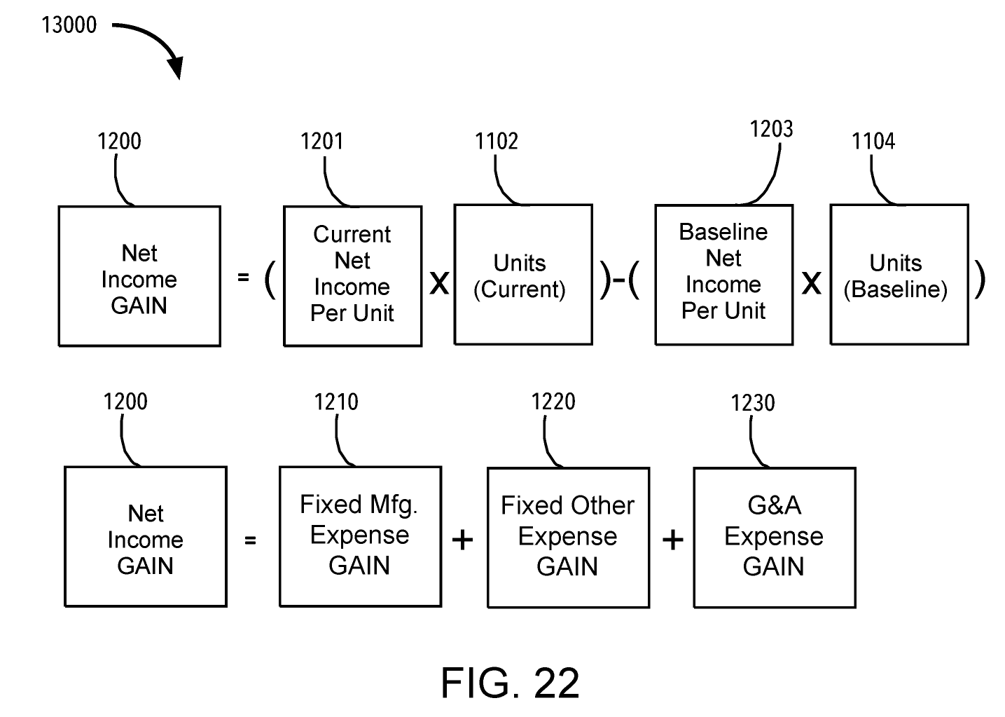

A multi-step method is illustrated in FIG. 21 as a schematic 12000, with additional detail in FIGS. 22-25. Schematic 12000 depicts the hierarchical relationship of Net Income Gain 1200 to its components Fixed Manufacturing Expense Gain 1210, Fixed Other Expense Gain 1220, and General and Administrative Expense Gain 1230.

Net Income is the difference between Cash Contribution and Fixed Expense. Net Income Gain 1200 is the sum of Fixed Manufacturing Expense Gain 1210, Fixed Other Expense Gain 1220, and General and Administrative Expense Gain 1230, between the base and current periods.

Fixed Manufacturing Expense Gain 1210 is the measure of changed fixed manufacturing-related overhead costs to products, in general, and to specific products, in particular, during the current time period as compared to fixed manufacturing-related overhead costs in the baseline period. Fixed Other Expense Gain 1220 is the measure of changed fixed non-manufacturing-related overhead costs to products, in general, and specific products, in particular, during the current time period as compared to fixed non-manufacturing-related overhead costs in the baseline period. Examples of fixed non-manufacturing related overhead cost include but are not limited to programs for promoting, marketing, and selling goods by product category, or customer, or region. General and Administrative Expense Gain 1230 is the measure of changed general and administrative overhead costs to products, in general, during the current time period as compared to general and administrative overhead costs in the baseline period.

The method outline in schematic 12000 thus describes how to compute Net Income Gain 1200 and its components Fixed Manufacturing Expense Gain 1210, Fixed Other Expense Gain 1220, and General and Administrative Expense Gain 1230.

Schematic 12000 thus describes the calculation of Net Income Gain 1200, comprising a multi-step method intended to describe changed profitability informed by the metric PPAH. Change is measured from a base set of data which reflects the business before any changes were implemented. When measuring the change from the base, the gain period data is comparable in time duration and seasonal effect to the base. The change attributable to each Net Income Gain 1200 component is a function of the changes inherent in the variables driving each of those components.

As shown in FIG. 22 as a diagram 13000, Net Income Gain 1200 is calculated. Net Income Gain 1200 is obtained by subtracting the Baseline Net Income per Unit 1203 multiplied by the Units (Baseline) 1104 from the Current Period Net Income Per Unit 1201 multiplied by the Units (Current) 1102. Furthermore, Net Income Gain 1200 is also obtained by adding Fixed Manufacturing Expense Gain 1210, Fixed Other Expense Gain 1220, and General and Administrative Expense Gain 1230.

The Baseline Net Income Per Unit represents the net income generated by products sold during the time range before changes had been implemented. By deducting Baseline Net Income Per Unit 1203 multiplied by the Units (Baseline) 1104 from Current Net Income Per Unit 1201 multiplied by the Units (Current) 1102 to compute Net Income Gain 1200, the method isolates the total change in net income during the period that was caused by some combination of fixed manufacturing expense, fixed other expense, and general and administrative expense changes.

The Net Income Gain 1200 or Aggregate Change in Net Income, is calculated by summing the changes in Net Income for each product. Each product's Net Income (NI) is calculated for the Baseline and Current Periods by multiplying the product's Net Income Per Unit (NIU(i)), by the number of product Units (U(i)) for the respective periods. The individual product calculations are:

NIG′(i)=(NIU′(i)*U′(i))−(NIU(i)*U(i), and

the aggregate for all products is calculated as:

$${\sum }_{i = 1}^{n} {NIG}^{′} ( i ) = ( {NIU}^{′} ( 1 ) * {U}^{′} ( 1 ) ) - ( NIU ( 1 ) * U ( 1 ) ) + ( {NIU}^{′} ( 2 ) * {U}^{′} ( 2 ) ) - ( NIU ( 2 ) * ( 2 ) ) + … + ( {NIU}^{′} ( n ) * {U}^{′} ( n ) - ( NIU ( n ) * U ( n ) )$$

Or, alternately,

$$Total {NIG}^{′}$$

$${\sum }_{i = 1}^{n} {FMEG}^{′} ( i ) + {\sum }_{i = 1}^{n} {FOEG}^{′} ( i ) + {\sum }_{i = 1}^{n} {GAEG}^{′} ( i )$$

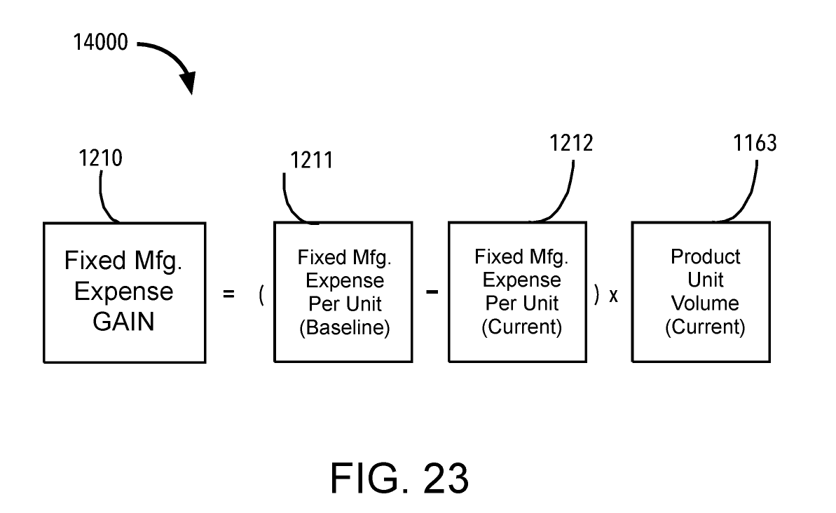

Next, as shown in FIG. 23 as diagram 14000, the Fixed Manufacturing Expense Gain (FMEG) 1210 is calculated. This is done by analyzing each product in the product database and comparing every single sales transaction for that product. Declines in fixed manufacturing costs cause increases in net income, while increases in fixed manufacturing costs will reduce net income. All fixed costs during the current time period, Fixed Manufacturing Expense Per Unit (Current) 1212 are subtracted from the fixed costs recorded in the baseline period for that product, Fixed Manufacturing Expense Per Unit (Baseline) 1211, and multiplied by the current period's quantity, Product Unit Volume (Current) 1163, to derive the product Fixed Manufacturing Expense Gain 1210 for each transaction. All the transactional fixed manufacturing expense gains are added together to compute the total Product Fixed Manufacturing Expense Gain 1210 for the product. Continuing, all Fixed Manufacturing Expense Gain values for all the products in the product database are added together to compute the total Product Fixed Manufacturing Expanse Gain 1210.

The product Fixed Manufacturing Expense Gain (FMEG) is calculated individually for each product as the change in the Fixed Manufacturing Expense per Unit (FMEU) multiplied by the Current Period Units (U).

It is noted that Fixed Manufacturing Expense changes are handled differently than Price changes since the Gain impact of cost changes are the opposite of Price changes.

The individual product calculation is:

FMEG′(i)=(FME(i)−FME′(i))*U′(i), and

the aggregate value is calculated as:

$${\sum }_{i = 1}^{n} {FMEG}^{′} ( i ) = ( FME ( 1 ) - {FME}^{′} ( 1 ) ) * {U}^{′} ( 1 ) + ( FME ( 2 ) - {FME}^{′} ( 2 ) ) * {U}^{′} ( 2 ) + … + ( FME ( n ) - {FME}^{′} ( n ) ) * {U}^{′} ( n ) .$$

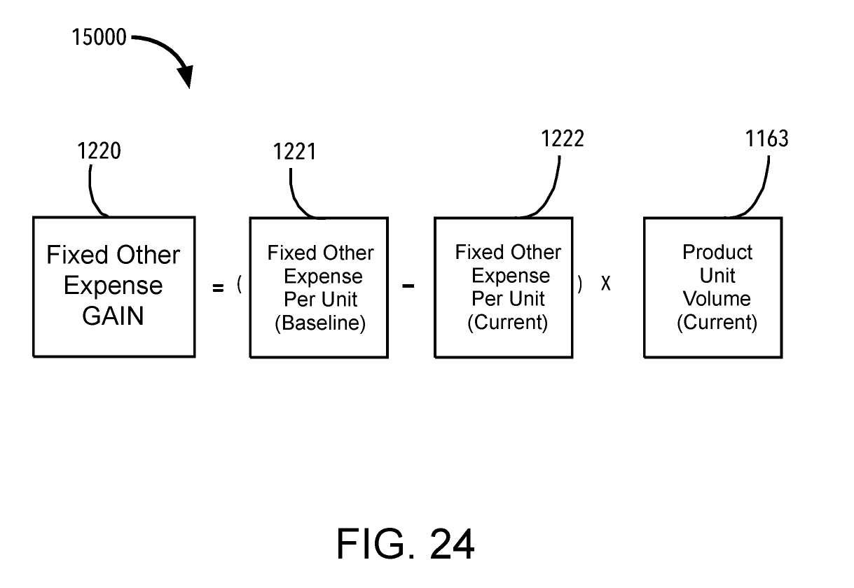

Next, as shown in FIG. 24 as diagram 15000, the Fixed Other Expense Gain 1220 is calculated. This is done by analyzing each product in the product database and comparing every single sales transaction for that product. Declines in fixed other costs cause increases in net income, while increases in fixed other costs will reduce net income. All fixed costs during the current time period, Fixed Other Expense Per Unit (Current) 1222 are subtracted from the fixed costs recorded in the baseline period for that product, Fixed Other Expense Per Unit (Baseline) 1221, and multiplied by the current period's quantity, Product Unit Volume (Current) 1163, to derive the product Fixed Other Expense Gain 1220 for each transaction. All the transactional Fixed Other Expense Gains are added together to compute the total product Fixed Other Expense Gain 1220 for the product. Continuing, all Fixed Other Expense Gain values for all the products in the product database are added together to compute the total product Fixed Other Expense Gain.

The product Fixed Other Expense Gain (FOEG) is calculated individually for each product as the change in the Fixed Other Expense (FOEU) multiplied by the Current Period Units (U).

It is noted that Fixed Other Expense changes are handled differently than Price since the Gain impact of cost changes are the opposite of Price changes.

The individual product calculation is:

FOEG′(i)=(FOE(i)−FOE′(i))*U′(i), and

the aggregate value is calculated as:

$${\sum }_{i = 1}^{n} {FOEG}^{′} ( i ) = ( FOE ( 1 ) - {FOE}^{′} ( 1 ) ) * {U}^{′} ( 1 ) + ( FOE ( 2 ) - {FOE}^{′} ( 2 ) ) * {U}^{′} ( 2 ) + … + ( FOE ( n ) - {FOE}^{′} ( n ) ) * {U}^{′} ( n ) .$$

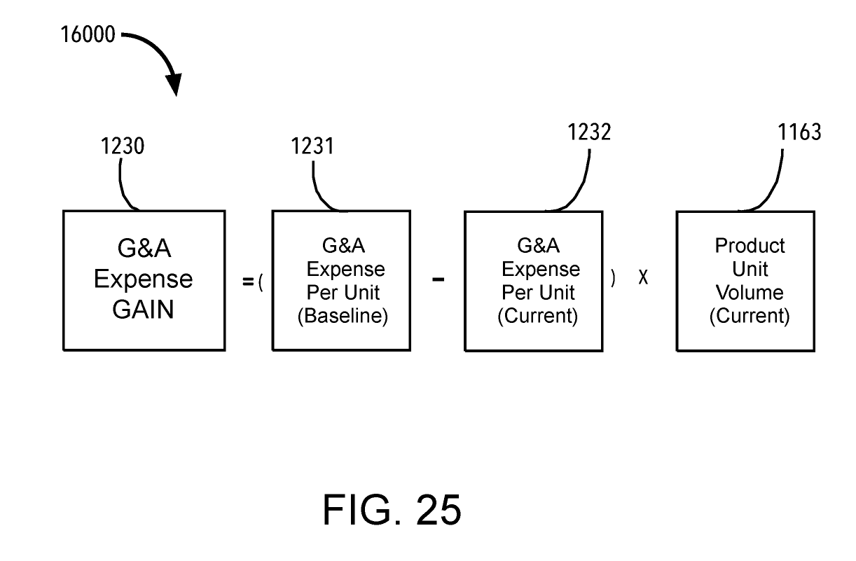

Next, as shown in FIG. 25 as diagram 16000, the General and Administrative Expense Gain 1230 is calculated. This is done by analyzing each product in the product database and comparing every single sales transaction for that product. Declines in general and administrative costs cause increases in net income, while increases in general and administrative costs will reduce net income. All fixed costs during the current time period, General and Administrative cost per unit (Current) 1232 are subtracted from the General and Administrative costs recorded in the baseline period for that product, General and Administrative Costs per unit (Baseline) 1231, and multiplied by the current period's quantity, Product Unit Volume (Current) 1163, to derive the product General and Administrative Expense Gain 1230 for each transaction. All the transactional general and administrative expense gains are added together to compute the total Product General and Administrative Expense Gain 1230 for the product. Continuing, all General and Administrative Expense Gain values for all the products in the product database are added together to compute the total Product General Administrative Expanse Gain.

The Product General and Administrative Expense Gain (GAEG) is calculated individually for each product as the change in the General and Administrative Expense per Unit (GAEU) multiplied by the Current Period Units (U).

It is noted that General and Administrative Expense changes are handled differently than Price changes since the Gain impact of cost changes are the opposite of Price changes.

The individual product calculation is:

GAEG′(i)=(GAE(i)−GAE′(i))*U′(i), and

the aggregate value is calculated as:

$${\sum }_{i = 1}^{n} {GAEG}^{′} ( i ) = ( GAE ( 1 ) - {GAE}^{′} ( 1 ) ) * {U}^{′} ( 1 ) + ( GAE ( 2 ) - {GAE}^{′} ( 2 ) ) * {U}^{′} ( 2 ) + … + ( GAE ( n ) - {GAE}^{′} ( n ) ) * {U}^{′} ( n ) .$$

### An Additional Example Machine Overview

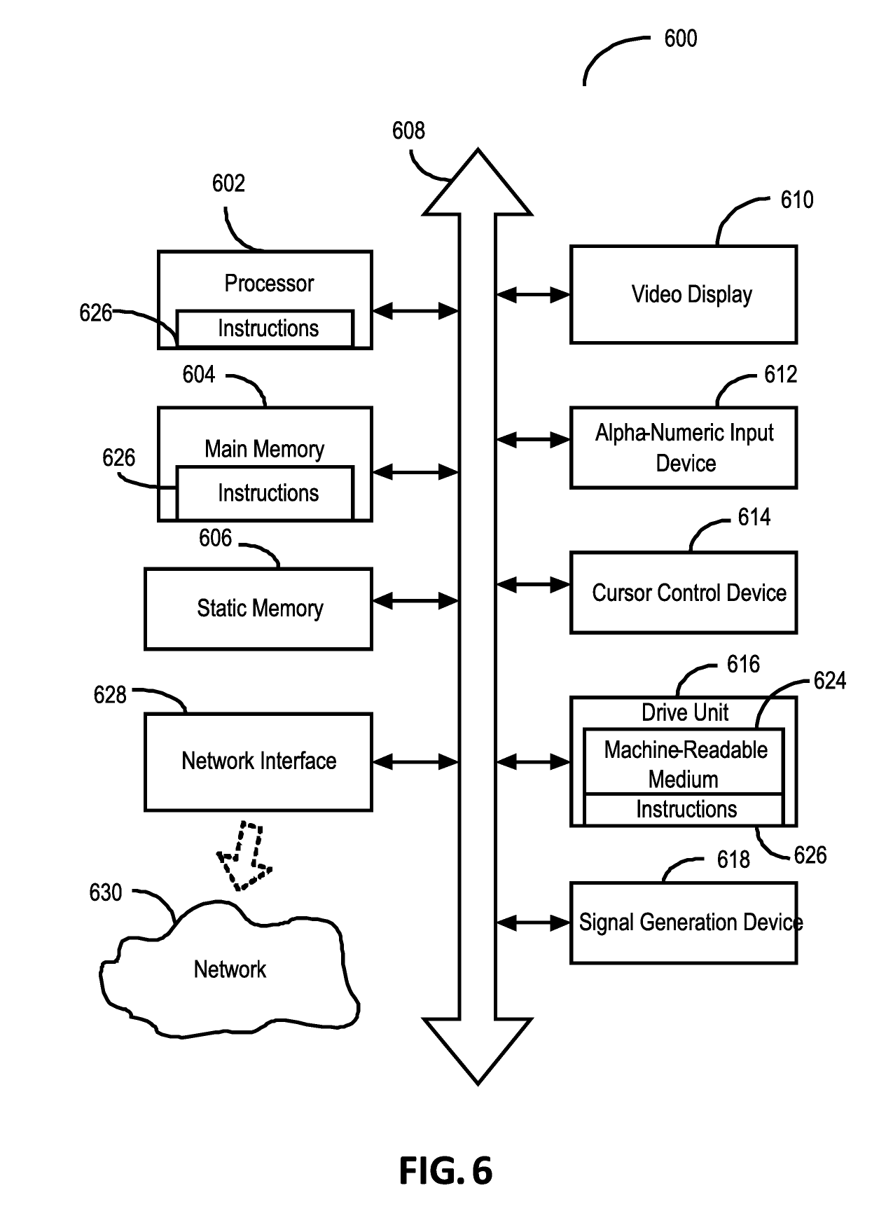

FIG. 6 is a block schematic diagram of a system in the exemplary form of a computer system 600 within which a set of instructions for causing the system to perform any one of the foregoing methodologies may be executed. In alternative embodiments, the system may comprise a network router, a network switch, a network bridge, personal digital assistant (PDA), a cellular telephone, a Web appliance, or any system capable of executing a sequence of instructions that specify actions to be taken by that system.

The computer system 600 includes a processor 602, a main memory 604, and a static memory 606 which communicate with each other via a bus 608. The computer system 600 may further include a display unit 610, for example, a liquid crystal display (LCD). The computer system 600 also includes an alphanumeric input device 612, for example, a keyboard; a cursor control device 614, for example, a mouse; a disk drive unit 616; a signal generation device 618, for example, a speaker; and a network interface device 628.

The disk drive unit 616 includes a machine-readable medium 624 on which is stored a set of executable instructions, i.e. software, 626 embodying any one, or all, of the methodologies described herein below. The software 626 is also shown to reside, completely or at least partially, within the main memory 604 and/or within the processor 602. The software 626 may further be transmitted or received over a network 630 by means of a network interface device 628.

In contrast to the system 600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer-readable medium. A machine-readable medium includes any mechanism for storing or transmitting information in a form readable by a machine, e.g. a computer. For example, a machine-readable medium includes read-only memory (ROM); random-access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Further, it is to be understood that embodiments may include performing operations and using storage with cloud computing. For the purposes of discussion herein, cloud computing may mean executing algorithms on any network that is accessible by internet-enabled or network-enabled devices, servers, or clients and that do not require complex hardware configurations, e.g. requiring cables and complex software configurations, e.g. requiring a consultant to install. For example, embodiments may provide one or more cloud computing solutions that enable users to obtain a profit improvement using a metric of PPAH for improving return on assets (ROA) on such internet-enabled or other network-enabled devices, servers, or clients. It further should be appreciated that one or more cloud computing embodiments may include providing a profit improvement using a metric of profit per asset-hour for improving return on assets (ROA) using mobile devices, tablets, and the like, as such devices are becoming standard consumer devices.

Although the invention is described herein with reference to the preferred embodiment, one skilled in the art may readily appreciate that other applications may be substituted for those set forth herein without departing from the spirit and scope of the present invention. Accordingly, the invention should only be limited by the claims included below.

What is claimed is:

1. A computer aided system for improving ROA and calculating a profit per asset-hour (PPAH) metric for a company manufacturing a plurality of different products using assets and having a plurality of TPM System databases comprising:
an Input Data database containing selected data from TPM System databases;
a processor disposed to receive a dataset from said Input Data database;
a Software Store operatively disposed with respect to said processor containing instructions which, when executed by said processor, generates a plurality of calculated results based on the data set from said Input Data database comprising: manufacturing ratios, profit ratios, the metric profit per asset-hour (PPAH);
a PPAH database operatively disposed with respect to said processor for storing the calculated results.

2. The computer aided system of claim 1 further comprising:
a TPM System having a TPM System database storing manufacturing and profit ratios and adapted to substitute said manufacturing and profit ratios with manufacturing ratios and profit ratios calculated by said processor.

3. The computer aided system of claim 1 further comprising:
a digital display device operatively disposed with respect to said PPAH database for displaying data in said PPAH database.

4. The computer aided system of claim 3 wherein said PPAH data base includes said data set.

5. The system of claim 2 further comprising:
a digital display device operatively disposed with respect to said PPAH database for displaying data in said PPAH database and where said PPAH database includes said data set.

6. The computer aided system of claim 5 wherein said calculated results include one or more Gain Attributes.

7. The system of claim 6 wherein the data from TPM Systems databases comprise any of: information on products sold, sales volumes, price of products, cost of product comprising direct and indirect costs, assets used in manufacturing each product, quantitative information on customers and products, seasonal material cost variations, overtime payment details.

8. The system of claim 2 wherein manufacturing ratios and profit ratios comprise any of: cost per unit, profit per unit, and units per asset-hour.

9. The system of claim 3 wherein data from the PPAH database displayed on said display device is a graph on which the PPAH of products is located relative to ROA.

10. The system of claim 9 wherein: the vertical axis of the graph is profit per unit and the horizontal axis of the graph is units per asset-hour and ROA is presented as a set of curves.

11. The system of claim 4 wherein the data from the PPAH database displayed on said display device is in the form of a chart comprising cells in columns and rows.

12. The system of claim 11 further configured to permit manually changing the values in any of the chart cells wherein said processor recalculates the cell values thereby providing simulation capability for increasing ROA by predicting and planning for an optimum product mix, customer mix, and asset mix using ROA criteria.

13. The system of claim 2 wherein the PPAH is computed for a plurality of products for product mix optimization.

14. The system of claim 2 wherein said TPM System is any one of a ERP system, financial reporting system, inventory and invoicing system, marketing system, manufacturing execution system, and production control system.

15. The system of claim 1 where in said calculated results include any of Gain Attributes:
Gross Cash Contribution Gain; Price Gain; Time Volume Gain; Cost Gain; Product Time Volume Gain; Product Time Mix Gain; Product Time Productivity Gain; Unit Volume Gain; Product Unit Volume Gain; Product Unit Mix Gain.

16. The system of claim 2 where in said calculated results include any of Gain Attributes:
Gross Cash Contribution Gain; Price Gain; Time Volume Gain; Cost Gain; Product Time Volume Gain; Product Time Mix Gain; Product Time Productivity Gain; Unit Volume Gain; Product Unit Volume Gain; Product Unit Mix Gain.

17. The system of claim 3 where in said calculated results include any of Gain Attributes:
Gross Cash Contribution Gain; Price Gain; Time Volume Gain; Cost Gain; Product Time Volume Gain; Product Time Mix Gain; Product Time Productivity Gain; Unit Volume Gain; Product Unit Volume Gain; Product Unit Mix Gain.

18. A method of operating a TPM System using a profit per asset-hour planning system (PPAHPS) comprising processing and storage units for a company producing a plurality of different products with assets and having TPM databases, the method comprising:
extracting TPM databases data sets of variable data, said variable data comprising any of sales quantities, prices, product costs, operating expenses, asset values, asset throughputs, and other production information;
extracting from TPM databases, information on customers and products and transitional information comprising any of seasonal raw-material cost changes, periodic demand increases, and competitive price variations;
generating profit ratios using the compiled and consolidated data and information from the Input Data database;
providing the generated profit ratios to the TPM System; and
operating the TPM System using the generated profit ratios.

19. The method of claim 18 wherein TPM System databases comprise data stored by any of ERP systems, financial reporting systems, inventory and invoicing systems, marketing systems, manufacturing execution systems, and production control systems.

20. The method of claim 18 wherein data from the Input Data database is used to compute financial and operational ratios.

21. The method of claim 18, further comprising:
compiling and consolidating the extracted data and information;
populating an Input Data database with compiled and consolidated data and information for use in generating profit ratios and a profit per asset-hour (PPAH) metric;
generating PPAH and generating a Gain Attribute using the compiled and consolidated data and information from the Input Data database;
populating and storing in the PPAH database the generated PPAH and generated Gain Attributes; and
allowing an end user to change any of the data stored in the PPAH database to generate estimates of profitability and to use said generated estimates of profitability to plan for increasing ROA.

22. A machine readable storage medium having stored thereon a computer program for generating quantitative production variables including profit per asset-hour (PPAH) as a guide to increase return on assets (ROA) for a company using assets to produce a plurality of different products, the computer program comprising:
a routine of set instructions for causing the machine to perform the steps of:
extracting selected data from one or more non-transitory TPM System databases wherein one or more of said databases includes production variables;
calculating various production variables from the extracted TPM System databases including profit per asset-hour (PPAH); and
displaying calculated results on a digital display device.

23. The machine readable storage medium of claim 18 wherein the machine performs the step of:
storing extracted selected data and calculated results in a non-transitory database; and
wherein the displayed calculated results further include extracted selected data which together with calculated results are displayed in an interactive format whereby one or more selected data or calculated results can be changed and new results calculated.

24. The machine readable storage medium of claim 18, wherein the machine performs the step of:
storing extracted selected data and calculated results in a non-transitory database; and
wherein the displayed calculated results is a graph on which the PPAH of individual products is located relative to ROA.
